(19) United States
(12) Patent Application Publication
(10) Pub. No.: US 2012/0212763 A1
(43) Pub. Date: Aug. 23, 2012

(54) INFORMATION PROCESSING DEVICE AND IMAGE OUTPUT SYSTEM

(75) Inventor: Tomoyuki Honma, Osaka-Shi (JP)

(73) Assignee: Sharp Kabushiki Kaisha, Osaka (JP)

(21) Appl. No.: 13/372,999

(22) Filed: Feb. 14, 2012

(30) Foreign Application Priority Data
Feb. 17, 2011 (JP) 2011-032513

(51) Int. Cl. G06F 3/12

(52) U.S. Cl. 358/1.13

(57) ABSTRACT

An information processing device includes: a data generating section generating compatible format data of application data; a selecting section causing selection of an output process among plural types of output processes that can use the compatible format data; a searching section searching image output device(s) connected on a network and extracting just an image output device at least capable of carrying out the selected output process; a disclosure/reception section disclosing the image output device extracted by the searching section and receiving a selection of an image output device serving as a compatible format data transmission destination, an entry of an output setting, and an instruction for executing the output setting; and a command generating section generating a command for causing the selected output process to be executed based on the entered output setting, upon receiving the instruction for executing the output process from the disclosure/reception section.

This Nonprovisional application claims priority under 35 U.S.C. §119(a) on Patent Application No. 2011-032513 filed in Japan on Feb. 17, 2011, the entire contents of which are hereby incorporated by reference.

### TECHNICAL FIELD

The present invention relates to an information processing device and an image output system, each of which use application data which has been converted into data of a compatible format file for printing.

### BACKGROUND ART

In recent years, with the spread of information processing devices (personal computers), an image output device that carries out an output process of image data transmitted from the information processing device has come into increasing use. Examples of the image output device encompass (i) a printer equipped only with a printing function, (ii) a multifunction printer which is equipped with, in addition to the printing function, a data transmission function such as a scanning function, a facsimile transmission function, and an e-mail transmission function, and (iii) an MFP (multifunction peripheral).

The image output device, in many cases, is connected to a network such as a LAN. At an office or the like, a plurality of image output devices are provided at a plurality of places. A user selects an image output device to use, out of the plurality of image output devices, in consideration of locations of the plurality of image output devices and a function(s) provided in each of the plurality of image output devices.

In order to print by use of a plurality of image output devices connected to a network, it is necessary that printer drivers for the respective plurality of image output devices be installed on an information processing device from which image data is transmitted.

Similarly, in order to transmit a facsimile by use of a plurality of image output devices connected to a network, it is necessary that facsimile drivers for the respective plurality of image output devices be installed on an information processing device from which image data is transmitted.

As such, every time an image output device is newly provided in an environment like the early-described office where a plurality of image output devices are provided, an IT administrator who is in charge of an information processing device and the plurality of image output devices contacts a user of the information processing device, which is under the supervision of the IT administrator, to have the user install a printer driver for the image output device that is newly provided.

However, the user of the information processing device might not bother to install the printer driver even if the user wants to use the image output device that has been newly provided. In such a case, this user has no chance to know the presence of such an image output device, let alone its functions.

Patent Literature 1 describes a technique of converting application data, which application data has been created on the basis of a given application program, into data in a form of a compatible format file for printing (hereinafter referred to as “compatible format data”), for example data in a form of a Portable Document Format (PDF) file. Conversion of the application data into the compatible format data allows a user of an information processing device to print out the compatible format data via any image output device capable of printing out the compatible format data, even if a printer driver for the image output device has not been installed on the information processing device.

Namely, use of this technique eliminates the need for the IT administrator to have the user of the information processing device install the printer driver, and the need for the user to install the printer driver.

### CITATION LIST

### Patent Literature

Patent Literature 1
Japanese Patent Application Publication, Tokukai, No. 2002-328795 A (Publication Date: Nov. 15, 2002)

Patent Literature 2
Japanese Patent Application Publication, Tokukaihei, No. 11-331455 A (Publication Date: Nov. 30, 1999)

### SUMMARY OF INVENTION

### Technical Problem

However, even though the image output devices capable of printing without requiring the installation of their respective printer driver is increased in number by converting the data into the compatible format data, a supporting system that allows for the user to effectively use the image output device has not been sufficiently prepared. Hence, the image output device has not been used effectively.

Moreover, the image output devices not only have the printing function, but may also have the following functions: a file conversion function for converting the compatible format data to TIFF data; a facsimile transmission function; an e-mail transmission function; an FTP transmission function; and like function.

For example, if an image output device has the file conversion function and the facsimile transmission function, the image output device should be able to convert the compatible format data into TIFF data by the file conversion function of the image output device and thereafter transmit a facsimile, when an instruction to carry out a facsimile transmission process is received at a time when the compatible format data is received.

Moreover, if an image output device has the file conversion function and the e-mail transmission function, the image output device should be able to convert the compatible format data into TIFF data by the file conversion function of the image output device and thereafter transmit an Internet-facsimile, when an instruction to carry out an e-mail transmission is received at a time when the compatible format data is received.

Alternatively, if an image output device has the FTP transmission function, the image output device should be able to transmit the compatible format data to a file server with use of the FTP function, when an instruction to carry out the FTP transmission is received at a time when the compatible format data is received.

Conventionally, there has been no technique where an information processing device not installing a driver that corresponds to an image output device transmits data to the image output device, and causes the image output device to carry out an output process other than printing, with use of such a compatible format data.

The present invention is accomplished in view of such a problem, and an object of the present invention is to provide an information processing device and an image output system, in which the information processing device not installing a driver of an image output device that corresponds to the information processing device is capable of transmitting data to that image output device and causing that image output device to carry out an output process other than printing.

### Solution to Problem

In order to attain the object, an information processing device of the present invention includes: data generating means for generating compatible format data of application data prepared based on an application program; selecting means for causing selection of an output process among a plurality of types of output processes capable of using the compatible format data; searching means for searching an image output device connected via a network and extracting just an image output device that is at least capable of carrying out the output process selected by the selecting means; disclosure/reception means for (i) disclosing the image output device extracted by the searching section, and (ii) receiving (a) a selection of an image output device serving as a transmission destination of the compatible format data, (b) an entry of an output setting, and (c) an instruction for executing the output process; and command generating means for generating a command for causing the selected output process to be executed based on the inputted output setting, upon receiving the instruction for executing the output process from the disclosure/reception section.

According to the configuration, data generating means generates compatible format data of application data that is prepared based on an application program.

Selecting means causes selection of a certain output process among a plurality of types of output processes capable of using the compatible format data. Examples of the output process using the compatible format data include, printing, facsimile transmission, Internet-facsimile transmission, e-mail transmission, or FTP transmission.

Searching means searches for image output devices connected on a network, and extracts, among the image output devices connected on the network, an image output device(s) capable of carrying out the output process selected by the selecting means.

The disclosure/reception means (i) discloses information of the extracted image output device, and (ii) receives (a) a selection of an image output device to serve as a transmission destination of the compatible format data, (b) an entry of output settings for the selected output process, and (c) an instruction to execute the output process.

Command generating means generates a command according to details received by the reception means. The generated command is attached to the compatible format data and is transmitted to the selected image output device.

This allows for carrying out an output process other than printing, which is capable of using the compatible format data, for example facsimile transmission, Internet-facsimile transmission, e-mail transmission, or FTP transmission, with use of an image output device provided on the network, whose driver of the image output device is not installed in the image processing device.

For example, in a case in which a user wishes to transmit a given application data by facsimile, an image output device that can transmit a facsimile with use of compatible format data, which image output device is provided on the network, is extracted and disclosed just by (i) instructing to convert the application data into compatible format data and (ii) selecting facsimile transmission as the output process. Accordingly, a user can transmit the given application data from a selected image output device by facsimile, just by (i) selecting an image output device to use among the disclosed image output device(s), (ii) entering the output settings, and (iii) instructing the image output device to carry out the output process.

Moreover, in a case of an office in which a plurality of image output devices are provided on a network, and although an image output device newly provided whose printer driver is not installed in the information processing device is present the presence of that image output device is not known, the information processing device of the present invention enables the user to use that new image output device within a range that the compatible format data can be used, since the information processing device can easily find the new image output device.

Particularly, if an output process other than printing is included as the output processes that are capable of using the compatible format data, many image output devices may become extracted. This requires finding out the image output device that is capable of carrying out the output process desired by the user, among the search results.

On the other hand, the above configuration extracts the image output devices that have been narrowed down to the image output devices that are capable of carrying out the desired output process. Hence, the desired output process can be carried out by any of the extracted image output devices. Hence, it is possible to promptly select the image output device with which the process is carried out, and carry out the output process promptly.

An image output system of the present invention includes: the information processing device of the present invention; and an image output device connected to the information processing device via a network, the image output device being capable of carrying out an output process that uses compatible format data.

The information processing device may be accomplished by a computer. In this case, a recording medium on which a program is stored, which program causes a computer to function as each of sections of an information processing device, is also included in the scope of the present invention.

### Advantageous Effects of Invention

According to the invention, it is possible to carry out an output process other than printing which is capable of using the compatible format data, for example facsimile transmission, Internet-facsimile transmission, e-mail transmission, or FTP transmission, with use of an image output device provided on the network, whose driver of the image output device is not installed in the image processing device. Furthermore, selection of a desired output process and carrying out of a search thereafter allows for narrowing down the plurality of image output devices available on the network to those that are capable of carrying out the selected output process. This allows for easily selecting an image output device which can carry out the process, and allows for promptly carrying out the process.

### BRIEF DESCRIPTION OF DRAWINGS

FIG. 1

FIG. 1 shows an embodiment of the present invention and is a block diagram illustrating functions of an information processing device and functions of an image output device that carries out output process with respect to image data transmitted from the information processing device.

FIG. 2

FIG. 2 is an explanatory view illustrating a configuration of an image output system including the information processing device.

FIG. 3

FIG. 3 is an explanatory view illustrating a setting window for printing in an application, the setting window being capable of activating a compatible format data generating section provided in the information processing device.

FIG. 4

FIG. 4 is a setting window for detailed settings of the compatible format data generating section, the setting window being displayed by clicking a button “detailed settings” on the setting window for printing illustrated in FIG. 3.

FIG. 5

FIG. 5 is an explanatory view illustrating a selecting window for selecting an output process carried out by use of compatible format data, which selecting window is displayed by clicking on “print” on the setting window for printing illustrated in FIG. 3.

FIG. 6

Each of (a) through (d) of FIG. 6 is an explanatory view illustrating an example of a selecting window for selecting an output setting, which selecting window is displayed after a button “setting” is clicked on the selecting window of output processes illustrated in FIG. 5; (a) is a selecting window for print settings, (b) is a selecting window for facsimile transmission settings, (c) is a selecting window for e-mail transmission settings, and (d) is a selecting window for Internet-facsimile transmission settings.

FIG. 7

FIG. 7 is an explanatory view illustrating an example of a search result which is obtained as a result of search carried out by a searching section of the information processing device and is to be stored in a storage section in the information processing device.

FIG. 8

FIG. 8 is an explanatory view illustrating an example of a latency table used in a latency determining section of the information processing device.

FIG. 9

Each of (a) and (b) of FIG. 9 is an explanatory view illustrating an example of a display window of a search result, which display window is displayed after a button “print” is clicked on the setting window for printing illustrated in FIG. 3.

FIG. 10

Each of (a) and (b) of FIG. 10 is an explanatory view illustrating an example of popup menus which are each displayed in response to clicking of a portion of the display window of the search result illustrated in (a) of FIG. 9, in which portion a corresponding one of image output devices is displayed, and which popup portions make it possible to select an output process from among output processes supported by the image output device.

FIG. 11

Each of (a) and (b) of FIG. 11 is an explanatory view illustrating examples of a popup menu which is displayed in response to clicking of a portion of the display window of the search result illustrated in (a) of FIG. 9, in which portion a corresponding one of the image output devices is displayed, and which popup menu makes it possible to further select a file format of data to be transmitted in a case where e-mail transmission is selected from output processes supported by the image output device.

FIG. 12

Each of (a) through (d) of FIG. 12 is an explanatory view showing a setting window for setting a process method, each of which setting window is displayed when a user clicks a desired function in each of windows illustrated in (a) and (b) of FIG. 10 and (a) and (b) of FIG. 11 for selecting an output process function; (a) shows a setting window for printing, (b) shows a setting window for facsimile transmission, (c) shows a setting window for e-mail transmission, and (d) shows a setting window for Internet-facsimile transmission.

FIG. 13

Each of (a) and (b) of FIG. 13 is an explanatory view illustrating another example of a setting window for printing.

FIG. 14

Each of (a) through (d) of FIG. 14 is an explanatory view showing an example of commands to be generated by a command generating section in the information processing device; (a) shows commands for printing, (b) shows commands for facsimile transmission, (c) shows commands for e-mail transmission, and (d) shows commands for Internet-facsimile transmission.

FIG. 15

FIG. 15 is a flowchart showing a sequence of processes which is carried out when the user instructs to generate compatible format data in the information processing device. The process starts by generating the compatible format data and ends by displaying a search result.

FIG. 16

FIG. 16 is a flowchart showing a sequence of processes which is carried out when the user selects an image output device on the display window of the search result in the information processing device. The process starts by displaying, in a menu, selectable output processes, and ends by transmitting compatible format data after creating commands.

FIG. 17

FIG. 17 illustrates another embodiment of the present invention, and is a block diagram illustrating functions of an information processing device and of an image output device which carries out output processes of image data transmitted from the information processing device.

FIG. 18

FIG. 18 illustrates another embodiment of the present invention, and is an explanatory view illustrating a selecting window for selecting an output process to be carried out with use of compatible format data, which selecting window is displayed after a button “print” is clicked on the setting window for printing, illustrated in FIG. 3.

FIG. 19

FIG. 19 is an explanatory view illustrating, in an information processing device of the another embodiment, an example displaying a popup menu which is displayed in response to a clicking of a portion of a display window of the search result, in which portion a corresponding one of image output devices is displayed, and which popup portions makes it possible to select a plurality of items from among output processes supported by the image output device.

FIG. 20

FIG. 20 is a flowchart showing a sequence of processes carried out by the information processing device of the another embodiment, which processes are carried out after the user selects an image output device on the display window of the search result of the information processing device. The process starts by displaying, in a menu, selectable output processes, and ends by transmitting compatible format data, after creating commands.

FIG. 21

FIG. 21 illustrates another embodiment of the present invention, and is a block diagram illustrating functions of an information processing device and of an image output device carrying out an output process to image data transmitted from the information processing device.

FIG. 22

FIG. 22 is a block diagram specifically illustrating a configuration of a searching section of the information processing device illustrated in FIG. 21.

FIG. 23

FIG. 23 is a block diagram specifically illustrating a configuration of a disclosure reception section of the information processing device illustrated in FIG. 21.

FIG. 24

FIG. 24 is a flowchart of a sequence of processes carried out by the information processing device illustrated in FIG. 21, which is carried out after the user instructs to generate compatible format data. The process starts by generating the compatible format data and ends by displaying a search result.

FIG. 25

FIG. 25 is an explanatory view illustrating an example in the information processing device illustrated in FIG. 21 of a display window of a search result in which no image output device that is capable of a printing process in a selected output setting is detected, and an alternative image output device is displayed.

FIG. 26

FIG. 26 illustrates another embodiment of the present invention, and is a block diagram illustrating functions of an information processing device and of an image output device that carries out an output process of image data transmitted from the information processing device.

FIG. 27

FIG. 27 is an explanatory view illustrating an example in the information processing device illustrated in FIG. 26 of a display window of a search result in which an image output device capable of carrying out the output process is displayed as a search result, for each selected plurality of output settings.

FIG. 28

FIG. 28 is a flowchart illustrating a sequence of processes carried out in the information processing device illustrated in FIG. 26, after a user instructs to generate compatible format data. The process starts by generating the compatible format data and ends by displaying a search result.

FIG. 29

FIG. 29 illustrates another embodiment of the present invention, and is a block diagram illustrating functions of an information processing device and of an image output device which outputs image data transmitted from the information processing device.

### DESCRIPTION OF EMBODIMENTS

### First Embodiment

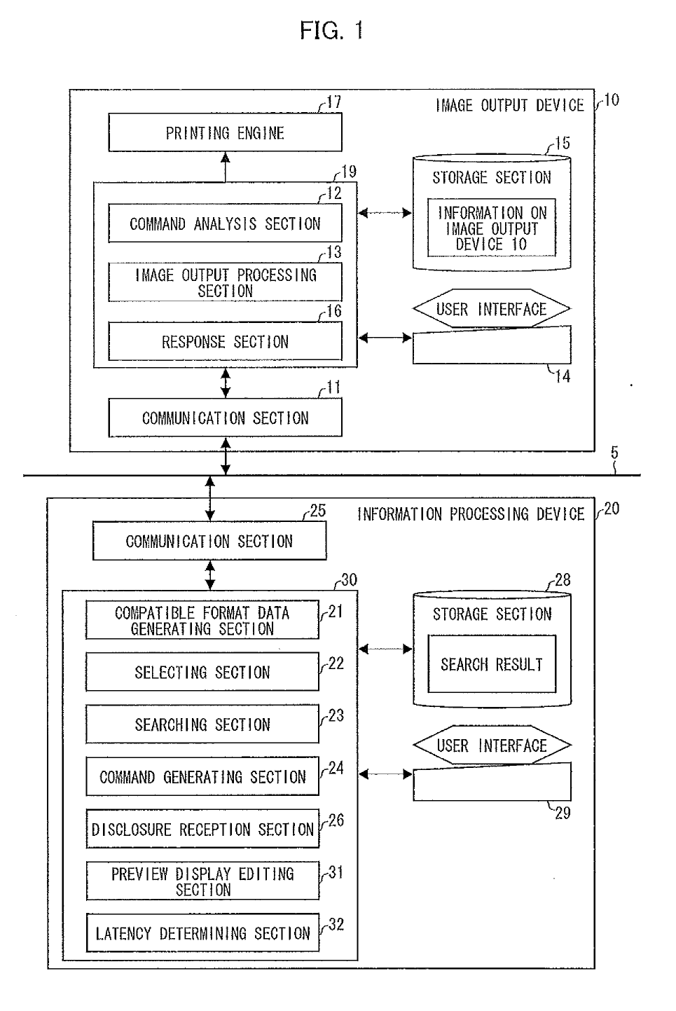

One embodiment of the present invention is described below, with reference to FIGS. 1 through 16.

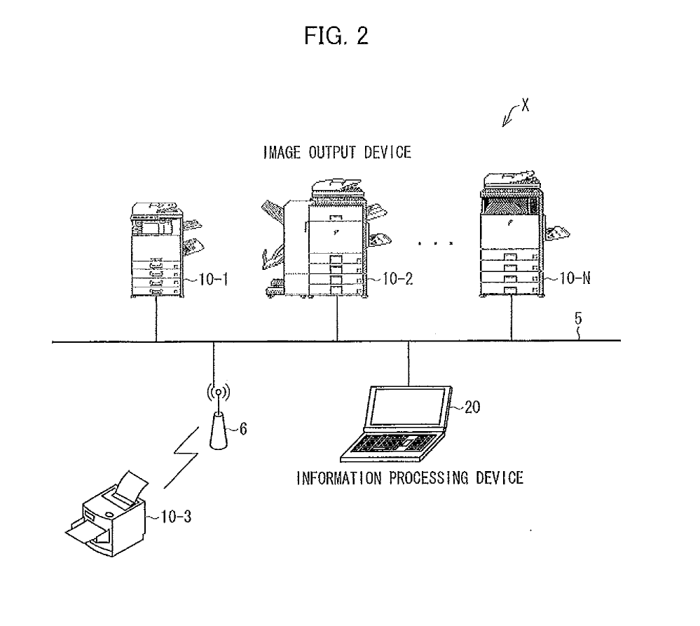

As illustrated in FIG. 2, in an image output system X in which an information processing device 20 in accordance with an embodiment of the present invention assists image output, the information processing device 20 is connected with a plurality of image output devices 10-1 through 10-N via a network 5 such as the Internet or the intranet.

The network 5 is an IP network or the like whose examples encompass an intranet/the Internet or the like such as a LAN, a wireless LAN, WiMAX, PLC, and c.link. The network 5 can be connected to an external network.

The plurality of image output devices 10-1 through 10-N are each an image output device having at least a printing function. Examples of the plurality of image output devices 10-1 through 10-N encompass a printer, a printer having a scanning function, a multifunction printer, and an MFP. In FIG. 2, the image output device 10-3 is a desktop printer including an internal wireless LAN client, and the reference sign 6 represents an access point of the wireless LAN. Hereinafter, unless it is necessary to separately distinguish the image output devices 10-1 to 10-N, these image output devices 10-1 to 10-N are described as image output device 10.

The information processing device 20 is an information processing device such as a PC/AT compatible machine and a MAC-based machine. Alternatively, the information processing device 20 can be a terminal such as a portable terminal for example a PDA. Instead of a single information processing device 20, a configuration may include a plurality of information processing devices 20, each of which has the same configuration as the information processing device 20 and is connected to the network 5.

FIG. 1 is a functional block diagram of the information processing device 20 and the image output device 10. The following description will first discuss the information processing device 20.

The information processing device 20 includes a compatible format data generating section (data generating section) 21, a selecting section 22, a searching section 23, a command generating section 24, a communication section 25, a disclosure reception section (disclosure/reception section) 26, a storage section 28, a user interface 29, a preview display editing section 31, and a latency determining section 32.

The compatible format data generating section 21 generates compatible format data of application data in various formats such as a document, a spreadsheet document, a vector image, a raster image, and a photograph, which application data are generated on the basis of various application programs (software).

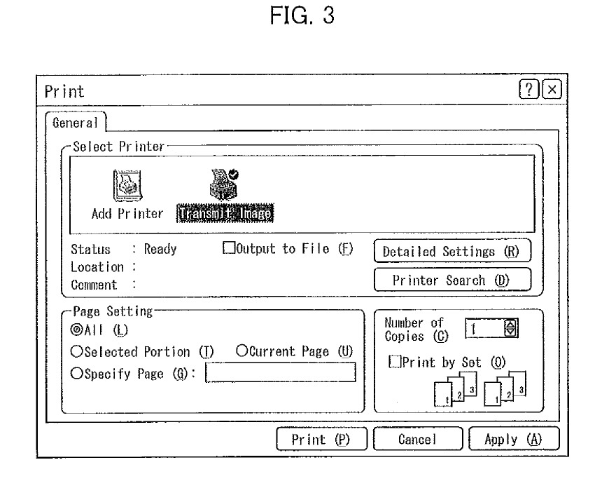

The compatible format data generating section 21 is a type of a printer driver and can be run at a time of carrying out printing in a given application. For instance, it is possible to run the compatible format data generating section 21 from a setting window for printing illustrated in FIG. 3 described later. Examples of a compatible format that can be printed out by a given image output device encompass Portable Document Format (PDF), XML Paper Specification (XPS), and the like. In the present embodiment, the compatible format is exemplified as the PDF.

The selecting section 22 causes the user to select an output process that uses the compatible format data, via the user interface 29. The output processes which can use the compatible format data are, for example, “print”, “facsimile transmission”, “Internet-facsimile transmission”, “e-mail transmission”, and “FTP transmission”.

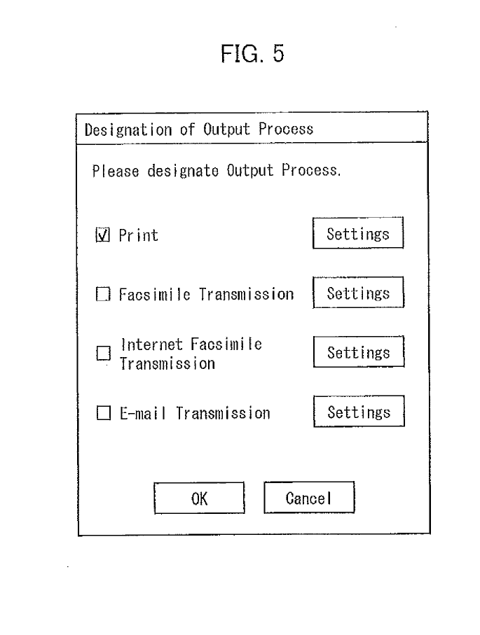

In the information processing device 20 of the present embodiment, after the generation of the compatible format data is started by the compatible format data generating section 21, the selecting section 22 displays a dialogue box for selecting an output process as illustrated in FIG. 5 described later, and causes the user to select among the following four items: “print”, “facsimile transmission”, “Internet-facsimile transmission”, and “e-mail transmission”.

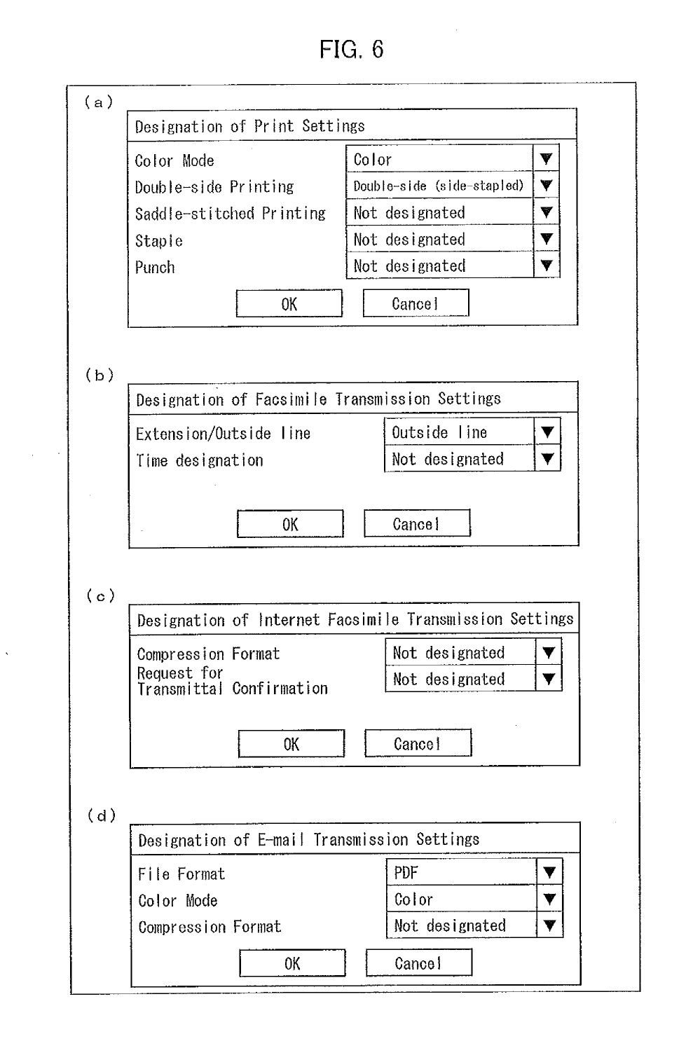

As a more preferable configuration, the selecting section 22 causes the user to select output settings for the output process. In the dialogue box for selecting the output process, a “setting” button is provided, to switch over to a dialogue box for selecting the output settings. By clicking this “setting” button, the dialogue box for selecting the output setting is displayed, as like those illustrated in (b) through (d) of FIG. 6 described later. This enables selecting of the output settings.

The searching section 23 searches for the image output devices 10-1 through 10-N that are connected to the network 5, via the communication section 25, to extract just the image output devices 10 that are at least capable of carrying out the output process selected in the selecting section 22.

A more preferable configuration allows for selecting output settings thereof. Accordingly, the searching section 23 extracts just the image output devices 10 that are capable of carrying out the output process selected in the selecting section 22, in the output settings selected in the selecting section 22.

The searching section 23 carries out its search by use of, for instance, SNMP (Simple Network Management Protocol) and WSD (WS-Discovery).

More specifically, after the generation of the compatible format data starts in the compatible format data generating section 21, the searching section 23 communicates with the image output devices 10-1 through 10-N connected via the network 5, and obtains information such as a model name, an option name, and an IP address of each of the image output functions supported by the image output devices 10 from the obtained model names and option names, and determines whether or not the image output devices 10 are capable of processing the compatible format.

As described above, in the information processing device 20 of the present embodiment, the output processes with which the compatible format data can be used are the following four items: “print”, “facsimile transmission”, “Internet-facsimile transmission”, and “e-mail transmission”. Hence, the searching section 23 determines that the image output device 10 including at least one of the processing functions of the four output processes is capable of processing the compatible format data.

However, with the “facsimile transmission” and the “Internet-facsimile transmission”, it is necessary to convert the compatible format data into TIFF data. Hence, the searching section 23 determines that the “facsimile transmission” can be carried out in a case where the image output device 10 has (i) a file conversion function which converts the compatible format data to TIFF data and (ii) the facsimile transmission function. Similarly, the searching section 23 determines that the image output device 10 is capable of “Internet-facsimile transmission” in a case where the image output device 10 has (i) the file conversion function and (ii) the Internet-facsimile transmission function.

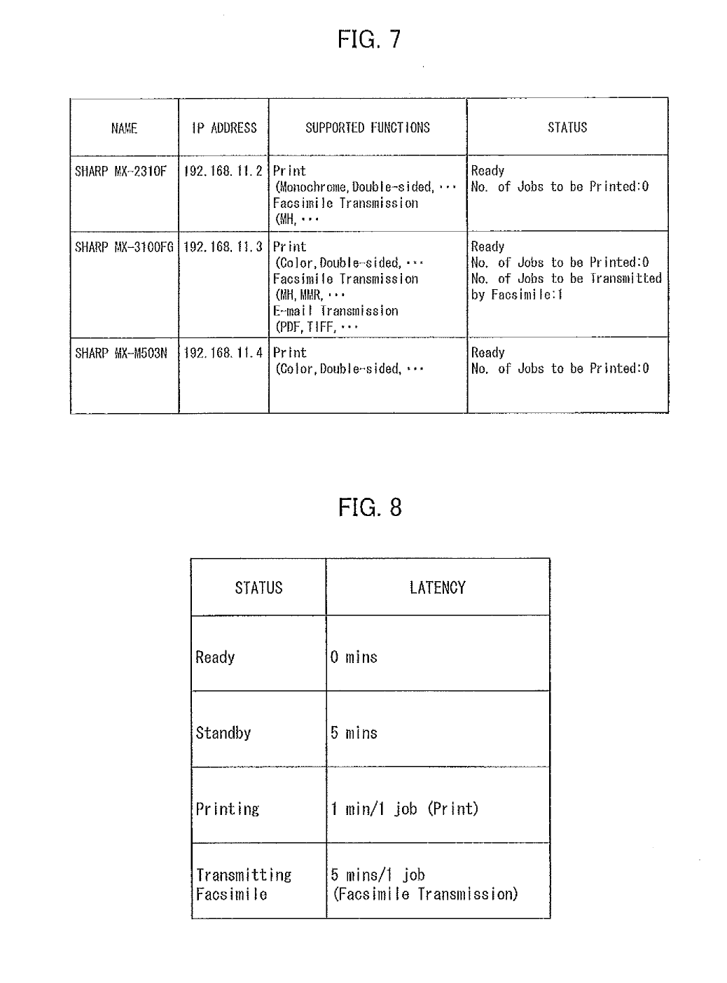

The information such as the model name, IP address, and supported functions of the image output device 10 determined as capable of processing the compatible format data, is stored in the storage section 28 as search result information (see FIG. 7).

Moreover, the searching section 23 identifies information of output settings which can be set, from the obtained model name and option name; this information is also stored as the search result in such a manner that the information is associated with its respective image output device 10. FIG. 7 illustrates an example in which information of output settings that can be set (in the case of the print function, information such as monochrome, color, double-side, etc.) is stored associated with the information of the supported functions.

Moreover, in a case where e-mail transmission can be carried out, the searching section 23 also obtains information of whether the image output device 10 has a function for converting compatible format data of PDF data into JPEG data or TIFF data.

Furthermore, as a more preferable configuration, in the information processing device 20 of the present embodiment, the searching section 23 also obtains information related to a current state of the image output device 10, which image output device 10 is extracted as being capable of carrying out the selected output process in the selected output settings.

More specifically, when the searching section 23 obtains the information such as the model name and option name upon communication with the image output devices 10-1 to 10-N connected on the network 5, the searching section 23 also obtains information related to a current state of the image output device 10. The obtained information is stored as the search result in such a manner that the information is associated with its respective image output device 10 (see FIG. 7), and is used for determination of latency by a latency determining section 32 later described.

The information processing device 20 of the present embodiment obtains status information of the image output device 10, as information related to the current state of the image output device 10. The status information of the image output device 10 includes operational information of the image output device 10 and the number of jobs that are waiting to be processed.

The operational information is information indicative of an operational state of the image output device 10 when the searching section 23 carried out an inquiry to the image output device 10. In the embodiment, four states are used as the operational information indicative of the operational states of the image output device 10: “ready”, “standby”, “printing”, and “transmitting facsimile”.

The “ready” is a state in which the image output device 10 can carry out an output process without any latency, and the “standby” is a state in which power of the image output device 10 is reduced to save power. The “printing” is a state in which the image output device 10 is in process of carrying out the printing process, and the “transmitting facsimile” is a state in which the facsimile transmission process is in process.

The “print” and “facsimile transmission” include information of whether or not the process is in progress in the status information, however the “Internet-facsimile transmission” and “e-mail transmission” do not include the information of whether or not the process is in progress in the status information. This is because the “Internet-facsimile transmission” and the “e-mail transmission” are short in their processing time, and the latency does not become a problem.

For the similar reason, the number of jobs that are waiting to be processed is obtained for the “print” and the “facsimile transmission”.

Other than this, some image output devices may allow setting of a “night time mode” or the like. This also serves as a cause for taking time to output a job instructed by the user, and thus is preferably included in the operational state.

Moreover, in the above configuration, the searching section 23 is configured to start searching as soon as the generation of the compatible format data by the compatible format data generating section 21 starts, without waiting until the selecting section 22 completes its selecting. However, the configuration may be one which the searching is started upon completion of the selection by the selecting section 22, and just the information of an image output device capable of carrying out the output process selected by the selecting section 22 or that of an image output device capable of carrying out the output process in the output settings, each selected by the selecting section 22, is stored in the storage section 28 as a search result.

The latency determining section 32 determines latency until the output process starts, based on the information related to the current state of the image output device capable of the output process, which information is obtained by the searching section 23. More specifically, the latency determining section 32 determines the latency of the image output devices 10 based on the obtained status information (operational state, and the number of jobs waiting to be processed) of the respective image output devices 10. The determination of the latency uses a latency determination table as like one illustrated in FIG. 8 described later, which latency determination table is stored in the storage section 28.

The storage section 28 is a memory such as an HDD. As described above, the storage section 28 stores a result of search carried out by the searching section 23 (search result), namely, (i) information on the model name, the IP address, and the like of the image output device 10 capable of using the compatible format data, (ii) information of functions supported by the image output device(s) 10, and (iii) information of a current state (status information) of the image output device(s) 10 (see FIG. 7). Moreover, the latency determination table (see FIG. 8) used by the latency determining section 32 is also stored in the storage section 28.

The disclosure reception section 26 discloses the image output device 10 extracted by the searching section 23 with use of the user interface 29, to cause a user to (1) select an image output device 10 to serve as a transmission destination of the compatible format data, (ii) enter the output settings, and (iii) instruct to carry out the output process, with use of the user interface 29.

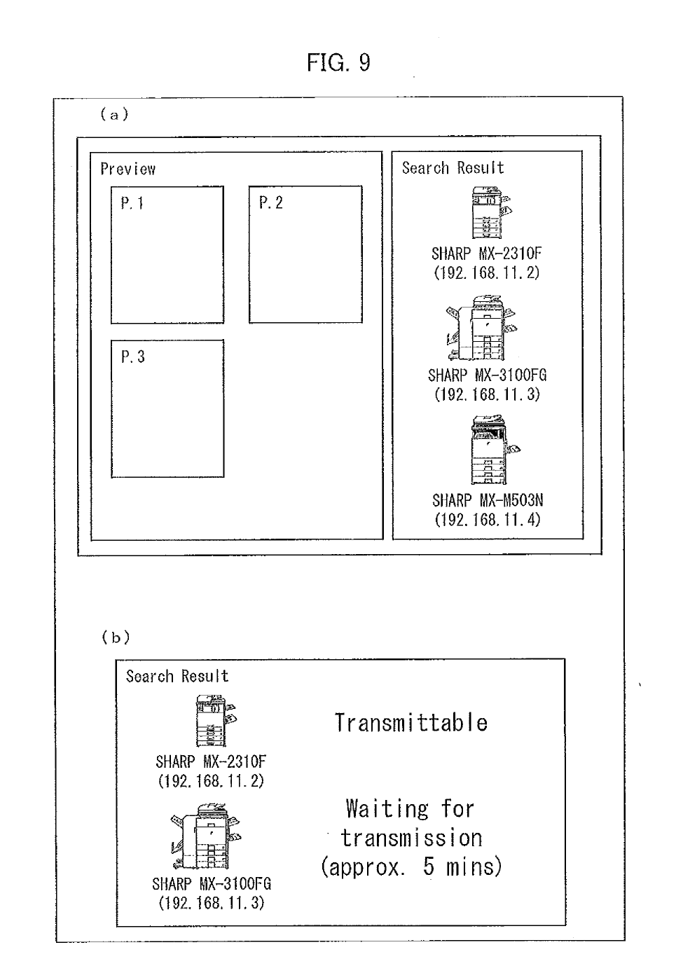

An example of a disclosure method is, as illustrated in (a) of FIG. 9 later described, displaying an icon showing an exterior view of the image output device 10 together with the model name of the device in the vicinity of the icon, on the display window of the user interface 29. A general disclosure method is to carry out display on a display window. However, for users with visual impairment, the disclosure method may be one in which a guide is provided so that the image output device 10 can be identified by audio.

Moreover, a more preferable configuration of the information processing device 20 of the present embodiment is that the latency determining section 32 is provided therein. In this case, the disclosure reception section 26 may disclose the latency information that is determined by the latency determining section 32 in such a manner that the latency information is associated with the image output device 10 to be disclosed, as illustrated in (b) of FIG. 9 later described. Moreover, in a case where a plurality of image output devices 10 are extracted by the searching section 23, the disclosure reception section 26 can arrange the extracted image output devices 10 in an order of shorter latency, based on the information of latency determined by the latency determining section 32.

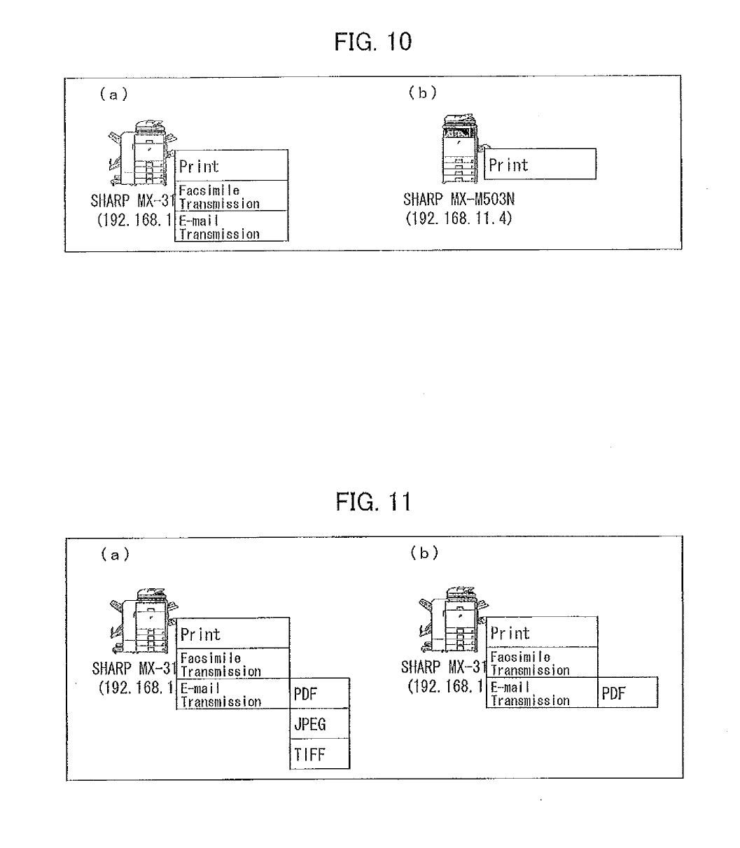

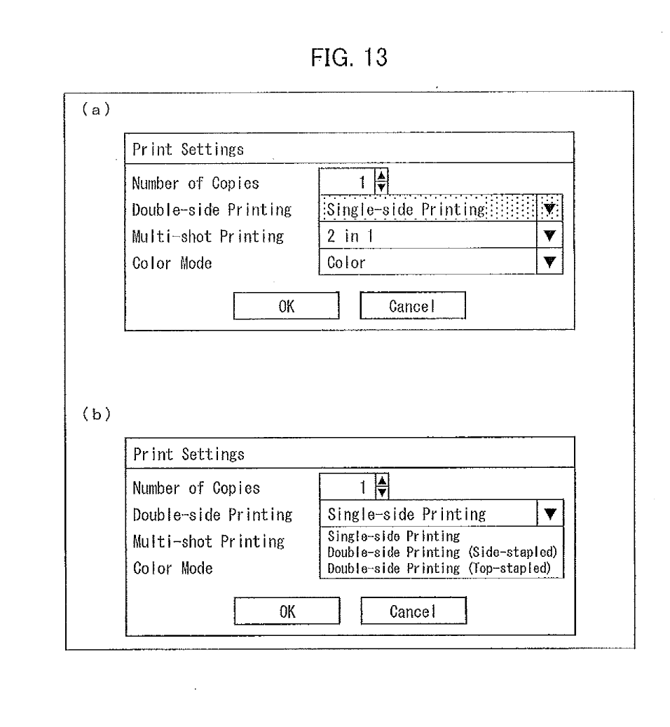

The disclosure reception section 26 receives, via the display window of the search result, the selection of the image output device 10 which is to serve as the transmission destination of the compatible format data. Moreover, a dialogue box for causing a user to set the output settings and to instruct to carry out the output process is displayed, as illustrated in (a) and (b) of FIG. 10 to (a) and (b) of FIG. 13, to cause the user to enter an instruction. The disclosure reception section 26 receives this instruction.

The preview display editing section 31 creates a preview image of the compatible format data generated by the compatible format data generating section 21 and displays the preview image by use of the user interface 29. The preview display editing section 31 receives, via the user interface, instructions from the user to change pages, carry out editing, and so on, on the preview display window.

In response to the disclosure reception section 26 receiving the instruction for execution, the command generating section 24 generates a command for causing the image output device 10 to execute a selected output process in accordance with a received output setting for the output process. A generated command is transmitted, together with the compatible format data, to a selected image output device 10.

The compatible format data generating section 21, the selecting section 22, the searching section 23, the latency determining section 312, the command generating section 24, the disclosure reception section 26, and the preview display editing section 31 constitute the control section 30. Though not shown in the drawing, the control section 30 is configured so that a CPU (i) executes a program stored in a ROM or a RAM and (ii) uses the RAM as a working area.

The communication section 25 transmits, via the network 5, (i) the compatible format data (the compatible format data may have been subjected, in the preview display editing section 31, to a process such as rearrangement of pages) generated by the compatible format data generating section 21 and (ii) the command generated by the command generating section 24, to the image output device 10 selected as the destination to which the compatible format data is transmitted. The compatible format data and the command can be transmitted by means of Line Printer daemon protocol (LPR), File Transfer Protocol (FTP), or the like.

The user interface 29 is constituted by a display device and instruction input devices such as a keyboard and a mouse.

The following description explains the image output device 10. The image output device 10 includes a communication section 11, a command analysis section 12, an image output processing section 13, a response section 16, a storage section 15, a user interface 14, and a printing engine 17.

The communication section 11 receives the compatible format data and the command transmitted from the information processing device 20. In a case where a facsimile transmission or an e-mail transmission is instructed as an output process, the communication section 11 transmits image data to a specified destination (telephone number, address).

The command analysis section 12 analyzes a received command so as to determine which one of the following functions is to be used as an output process of the image data: printing, facsimile transmission, Internet facsimile transmission, or e-mail transmission. In a case where the output process is determined to be printing, the command analysis section 12 determines a print setting. In a case where the output process is determined to be any of the various transmission processes, the command analysis section 12 determines a destination setting and the like.

The image output processing section 13 outputs the received compatible format data in accordance with the setting determined by the command analysis section 12. In a case where the compatible format data is to be outputted by printing, the image output processing section 13 supplies, to the printing engine 17, the compatible format data together with a condition for the print setting determined by the command analysis section 12.

In a case where the compatible format data is to be outputted by any of the facsimile transmission, the Internet-facsimile transmission, or the like, the image output processing section 13 first converts the compatible format data into TIFF file data and then transmits, to the communication section 11, the TIFF file data together with the destination setting and the like. In a case where the compatible format data is to be outputted by an e-mail transmission, the image output processing section 13 transmits, to the communication section 11, the compatible format data together with the destination setting and the like, either (i) without making a change in format of the compatible format data or (ii) after converting the compatible format data into data in a specified data format in a case where such a data format has been specified. The same applies in a case of FTP transmission.

Upon receipt of an inquiry via the communication section 11 from the searching section 23 in the information processing device 20 on the network 5, the response section 16 responds to the inquiry by reading out, from the storage section 15, at least (a) a model name of the image output device 10, (b) an option name, and (c) an IP address of the image output device 10. The response section 16 also transmits status information indicative of a current state of the image output device 10.

The command analysis section 12, the image output processing section 13, and the response section 16 constitute the control section 19. Though not shown in the drawings, the control section 19 is configured so that a CPU (i) executes a program stored in a ROM or a RAM and (ii) uses the RAM as a working area.

The storage section 15 is a memory such as an HDD and stores at least information on the image output device 10 in which the storage section 15 is provided. Specifically, the storage section 15 stores at least information on the model name, the option names, the IP address, and like information of the image output device 10.

The user interface 14 is constituted by a display device and instruction input devices such as a keyboard and a mouse.

The following describes in more detail of the information processing device 20, with reference to FIGS. 3 through 18.

FIG. 3 illustrates a window for activating the compatible format data generating section 21 in the information processing device 20. The window is a print window opened by specifying “print” in a given application. By selecting the “transmit image” button in the “select printer” box and clicking the “print” button in the print window, it is possible to generate compatible format data of application data which has been activated when the print window was opened. Note that the information processing device 20 of the present embodiment is exemplified as an information processing device in which a display button is selected by clicking the display button by means of a mouse. The present embodiment is not limited to this. In case of an information processing device with a touch panel, a display button is selected by being pressed (i.e., touched).

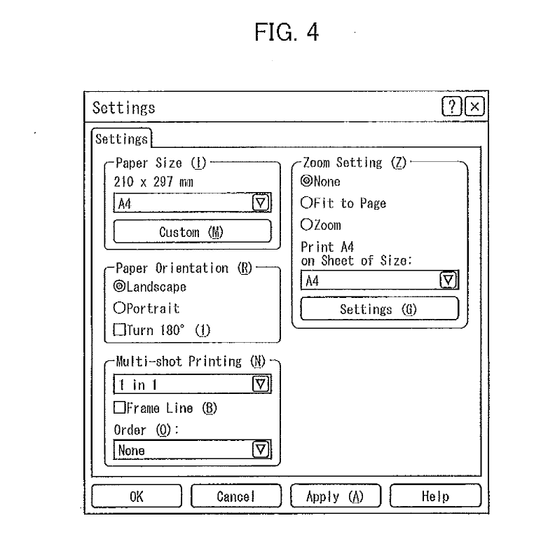

Clicking of the “detailed settings” button in the window of FIG. 3 causes a dialogue box to be displayed as illustrated in FIG. 4. The dialogue box allows settings to be made for preparation of the compatible format data. In the window of FIG. 4, it is possible to set a paper size, a paper orientation, multi-shot printing, and a magnitude of zooming. Clicking of “OK” in the window causes the settings to be enabled and allows the user to return to the window of FIG. 3.

In a case where the detailed settings are determined in the window of FIG. 4 so as to instruct to make a change from default settings, the compatible format data generating section 21 generates, in response to a clicking of the “print” button of FIG. 3, the compatible format data on the basis of the detailed settings determined in the window illustrated in FIG. 4. For example, in a case where the “multi-shot printing” is set to “2 in 1”, the compatible format data generating section 21 generates compatible format data which is to be printed out two pages per sheet.

The information processing device 20 is thus configured so that the compatible format data generating section 21 is activated from the window for printing out the application data from which the compatible format data is generated.

A request for printing is generally made in a state in which the application data has been opened. As such, it is possible to facilitate instruction by activating the compatible format data generating section 21 on the window for printing out the application data.

In addition, the window for printing out is an instruction window that is used more often than windows for instructing transmission and the like. As such, it is especially stress-reducing for an unskilled user to be able to select an output process, other than printing, on the window that the user is well used to.

The compatible format data generating section 21 is not limited to the configuration in which the compatible format data is generated from this state in which the application has been activated. For instance, the configuration may be one in which the compatible format data is generated by (i) creating in advance an icon for the compatible format data generating section 21 and (ii) dragging and dropping, onto the icon, a file of the application data to be subjected to the output process.

This configuration is convenient for a skilled user, because the user can instruct creation of the compatible format data without running the application.

FIG. 5 illustrates a dialogue box displayed on the selecting section 22, for the user to select (designate) an output method. The dialogue box is displayed when (i) the “print” button of FIG. 3 is clicked or (ii) the file of the application data to be subjected to the output process is dragged and dropped onto the icon of the compatible format data generating section 21.

In this dialogue box, it is possible to select (designate) an output process among the four processes, “print”, “facsimile transmission”, “Internet-facsimile transmission”, and “e-mail transmission”. The example in FIG. 5 illustrates a state in which a user selects to search for an image output device that can “print” the generated compatible format data.

By clicking the “OK” button on the dialogue box illustrated in FIG. 5, a search result which extracts the image output device 10 capable of carrying out the selected output process is displayed. Moreover, if the “cancel” button is clicked on the dialogue box illustrated in FIG. 5, a search result that is not limited in the output method is displayed. Similarly, if the “OK” button is clicked in a state in which no output process is selected in the dialogue box illustrated in FIG. 5, a search result not limited in the output method is displayed.

Moreover, clicking on the “setting” button provided on the side of each of the output processes in the dialogue box illustrated in FIG. 5 causes display of a dialogue box for selecting (designating) output settings for that respective output process, as illustrated in (a) through (d) of FIG. 6.

(a) of FIG. 6 illustrates an example where selection is made so that an image output device capable of selecting, as output settings for printing (print settings), “color” in “color mode” and “double-side (side-stapled)” in “double-side printing”, is to be searched for. Moreover, it is illustrated in this example that “saddle-stitched printing”, “staple”, and “punch” are not particularly set as conditions for the search. Selectable conditions can be selected by clicking on the “V” mark on each of sides of the “color mode”, “double-side printing”, “saddle-stitched printing”, “staple”, and “punch”.

Moreover, (b) of FIG. 6 illustrates an example in which selection is made so that as an output setting of facsimile transmission (facsimile transmission setting), an image output device capable of selecting “extension” in “extension/outside-line” is to be searched for. Moreover, the example shows that “time designation” is not particularly set as a condition for search.

(c) of FIG. 6 illustrates an example that as the conditions for the search, particularly no setting is set as the output settings for the Internet-facsimile transmission (Internet-facsimile transmission settings).

(d) of FIG. 6 illustrates an example where selection is made so that as output settings of e-mail transmission (e-mail transmission setting), an image output device capable of selecting “PDF” in “file format” and “color” in “color mode” is to be searched for. Moreover, the example shows that the “compressed format” is not particularly set as a condition for the search.

By clicking the “OK” button in the dialogue boxes as illustrated in (a) through (d) of FIG. 6, the setting of the output settings selected in each of the windows of (a) through (d) of FIG. 6 are made effective, and the display returns to the dialogue box for selecting the output process as illustrated in FIG. 5. Thereafter, by clicking the “OK” button in the dialogue box illustrated in FIG. 5, just the image output devices 10 capable of carrying out the output processes of the output compatible format data in the output settings selected in the windows of (a) through (d) of FIG. 6, which output processes are selected in the window of FIG. 5, are extracted and are displayed as a search result.

In a case where the “cancel” button is clicked in the window of (a) through (d) of FIG. 6, the display returns to the dialogue box for selecting the output process as illustrated in FIG. 5. In this case, the settings of the output setting selected in the windows of (a) to (d) of FIG. 6 are made invalid.

In the embodiment, the configuration is one which a dialogue box for selecting (designating) the output settings is displayed by clicking the “setting” button even for the output processes not selected in the dialogue box illustrated in FIG. 5. However, the configuration may be one in which a dialogue box for selecting (designating) the output settings is displayed upon clicking the “setting” button just for the output processes that has been selected.

The searching of the image output devices 10 by the searching section 23 of the information processing device 20 is started by clicking on the “print” button illustrated in FIG. 3 or by dragging and dropping, on an icon of the compatible format data generating section 21, a file of application data that is to be subjected to the output process, whereby information of the model name, option name, IP address and the like of the image output device 10 capable of using the compatible format data is obtained.

FIG. 7 illustrates an example of a search result which is obtained as a result of the search carried out by the searching section 23 and is to be stored in the storage section 28 as information of the image output device 10 capable of using the compatible format data.

As described earlier, the searching section 23 (i) communicates with each image output device 10 of the plurality of the image output devices 10-1 through 10-N provided on the network and (ii) determines, on the basis of a response from the response section 16 in the image output device 10, whether or not the image output device 10 is capable of processing the compatible format data. In a case where the image output device 10 is capable of processing the compatible format data, information such as the model name, IP address and functions supported by the image output device 10, information of output settings that can be set in the image output device 10, status information and like information, are stored in the storage section 28.

What kind of output processes are available as output processes that can use the compatible format data and what kind of output setting can be set may be determined by, for example, the model name and option name of the device. By storing the supported functions and capable output settings associated with the model name and option name of the device, it is possible to identify the supported functions and settable output settings from the model name and option name of the device.

For example, in a case where the searching section 23 uses an SNMP protocol, the searching section 23 refers to MIB data built in each of the image output devices 10-1 through 10-N. The SNMP protocol is a generally used protocol in which, when an ID (called an OID) is specified, a value set for the ID is returned, the value being contained in the MIB in the image output device 10.

The image output devices 10-1 through 10-N have a shared ID that is defined as printer-related information. The shared ID allows obtaining of information such as the model name, the option name, a tray name, and a paper size set for the tray. The searching section 23 can determine, on the basis of the model name and the option name thus obtained, the function supported by the respective image output device 10, and can specify a function in which the compatible format data can be processed and the output settings that can be set. The MIB data is stored in the storage section 15 in the image output device 10. The response section 16 responds to a communication in which the SNMP protocol is used.

The example of FIG. 7 illustrates that an image output device 10 having a model name “SHARP MX-2310F” has the functions “print” and “facsimile transmission” as the functions in which the compatible format data can be used, and that its status information is “ready” and “number of jobs to be printed: 0”.

Moreover, the image output device 10 of a model name “SHARP MX-3100FG” has three functions that are capable of using the compatible format data, being “print”, “facsimile transmission”, and “e-mail transmission”, and shows that the status information is “ready”, “number of jobs to be printed: 0”, and “number of jobs to be transmitted by facsimile: 1”.

The image output device 10 of a model name “SHARP MX-M503N” has just the function “print” as the function capable of using the compatible format data, and its status information is “standby” and “number of jobs to be printed: 0”.

(a) of FIG. 9 illustrates an example of a display window of a search result displayed in a case where the function “print” is selected by the user in the dialogue box illustrated in FIG. 5, which display result is displayed based on the search result information illustrated in FIG. 7. In the example of (a) of FIG. 9, the image output devices 10 of “SHARP MX-2310F”, “SHARP MX-3100FG”, and “SHARP MX-M503N”, each of which are capable of carrying out the “print” function selected by the user, are displayed on the display window. The display of the search result lists, for example, the model names and IP addresses together with icons imitating the exterior view of the devices.

By clicking on the icon of the preferable image output device in the window displaying such a search result, it is possible to select an image output device 10 with which the compatible format data is transmitted, and the process is carried out.

Illustrated in (a) of FIG. 9 shows an example in which the preview display editing section 31 displays (i) the preview image of the compatible format data and (ii) the search result disclosed by the disclosure reception section 26.

The user of the information processing device 20 can check the compatible format data of the given application data in the preview image which is being displayed. The user can also carry out editing on the preview display window. For example, the user can change an order of pages of the compatible format data by rearranging images on the respective pages (P.1, P.2, and P.3) by use of a mouse or the like.

Moreover, as another example of the display window of the search result, (b) of FIG. 9 illustrates a display window in which latency information determined by the latency determining section 32 is displayed together in the display window of the search result. (b) of FIG. 9 is a window displayed in a case where the user selects the “facsimile transmission” in the dialogue box illustrated in FIG. 5, which window is displayed based on the search result information for example illustrated in FIG. 7. In the example of (b) of FIG. 9, the image output devices 10 of “SHARP MX-2310F” and “SHARP MX-3100FG”, each of which are capable of the “facsimile transmission” selected by the user are displayed, and in the vicinity of the icons of the devices, “transmittable” and “waiting for transmission (approx. 5 mins)”, which are information indicative of latency of the image output devices 10, are respectively displayed.

As a result, the user can easily select an image output device 10 having few latency among the image output devices 10 capable of the “facsimile transmission”.

The latency determining section 32 determines the latency based on a latency table illustrated in FIG. 8, in accordance with status information. In the example of FIG. 8, the latency is set for each of the operational states of “ready”, “standby”, “printing”, and “transmitting facsimile”. The latency in the operational states is, “0 mins” in the case of ready, and “5 mins” in the case of standby since it takes time to restart. For cases where the process is in progress, there is the need to wait until the progressing process terminates, so therefore the latency is fixed so that with printing, it is “1 min per job”, and for transmitting facsimile, it is “5 mins per job”.

The latency determining section 32 determines the latency of the image output device 10 of the model name “SHARP MX-2310F” as “0 mins”, based on the status information (“ready”, “number of jobs to be printed: 0”) and the latency table of FIG. 8. The disclosure reception section 26 displays this determination result as “transmittable”.

Moreover, the latency determining section 32 determines the latency of the image output device 10 of the model name “SHARP MX-3100FG” as “5 mins”, which is one job worth of the facsimile transmission, based on the status information (“ready”, “number of jobs to be printed: 0”, “number of jobs to be facsimile transmitted: 1”) and the latency table illustrated in FIG. 8. The disclosure reception section 26 displays this determination result as “waiting for transmission (5 mins)”.

Note that, in a case in which (i) a large number of image output devices 10 capable of processing the compatible format data are detected and (ii) a size of the display window does not allow all of the image output devices 10 to fit in the list to be displayed in the display window of the search result, it is also possible to employ a configuration in which a sign “▾”, which indicates that a next window is available, is displayed so as to allow all of the detected image output devices 10 to be displayed by scrolling the display window.

When one of the displayed image output devices 10 is clicked on the display window of the search result, a popup menu for selecting an output process among all output processes that can be processed by the clicked image output device 10 with use of the compatible format data is displayed, as illustrated in (a) and (b) of FIG. 10. Alternatively, the information displayed on such a popup menu may be together displayed on the window of the search result.

(a) of FIG. 10 is displayed when the user clicks the icon of the image output device 10 whose device name is “SHARP MX-3100FG” on the display window of the search result of (a) of FIG. 9. (a) of FIG. 10 discloses to the user that the function of “print”, “facsimile transmission”, or “e-mail transmission” can be selected as the output process. The disclosure reception section 26 discloses such information on the basis of the search result stored in the storage section 28 (see FIG. 7).

(b) of FIG. 10 is displayed in response to the user clicking the icon of the image output device 10 whose device name is “SHARP MX-M503N” in the display window of the search result of (a) of FIG. 9. (b) of FIG. 10 discloses to the user that only the function “print” can be selected as the output process.

The display of such a popup menu allows for, in a dialogue box for selecting an output process, switching over from a state in which the function “print” is selected, and just the image output devices 10 capable of the “print” process are extracted and displayed to a state in which a completely different output process such as the “e-mail transmission” or the like is selected. Hereinafter, such a selection of the output process selected after displaying the display window of the search result is called reselection of an output process, to distinguish this selection from the selection of the output process carried out by the selecting section 22.

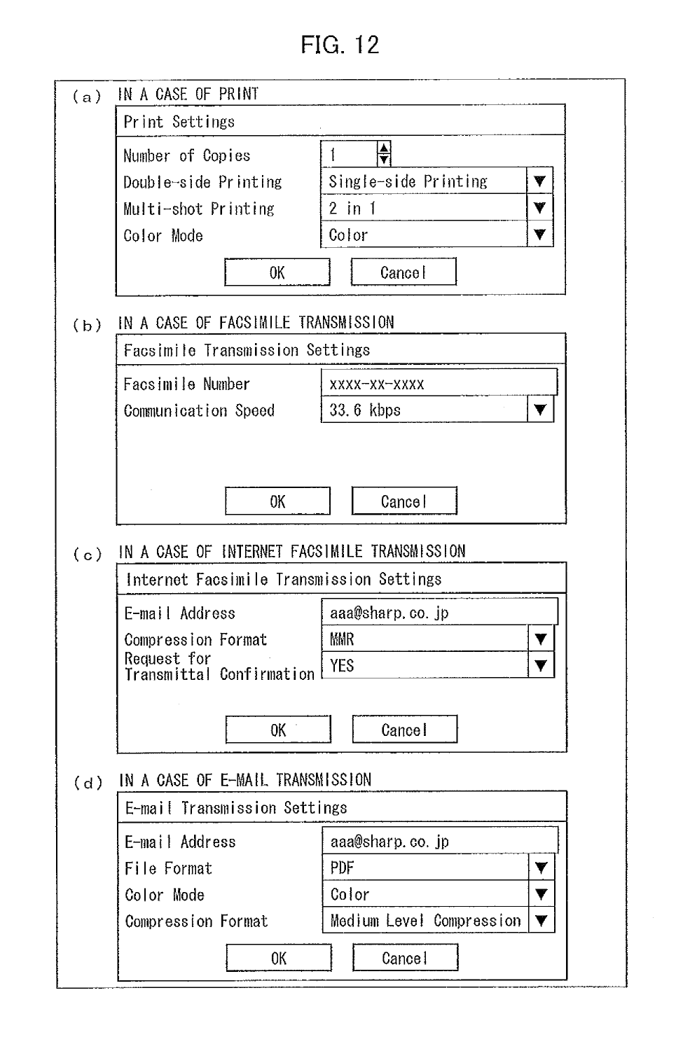

Of course, this reselection is not essential, and the configuration may be one in which a dialogue box illustrated in (a) through (d) of FIG. 12 is displayed, where the output settings for the output process selected in the dialogue box illustrated in FIG. 5 is set when the icon of the image output device 10 displayed on the display window of the search result is clicked.

In a case where the information obtained from the searching section 23 proves that such an image output device 10 has a function of converting PDF data into JPEG data and/or a function of converting PDF data into TIFF data, it is possible to employ the following configuration. According to the configuration, a format of data to be transmitted can be selected from “PDF”, “JPEG”, and “TIFF”, in a case where “e-mail transmission” is selected as the output process.

(a) of FIG. 11 is a window that further enables, in “e-mail transmission”, a selection of a format of data to be transmitted, from “PDF”, “JPEG”, and “TIFF”. (b) of FIG. 11 is a window that causes the user, in “e-mail transmission”, to understand that only “PDF” is available as a format of data to be transmitted.

In response to the user clicking a desired function on the windows for selecting an output process function shown in (a) and (b) of FIG. 10 and (a) and (b) of FIG. 11, the disclosure reception section 26 displays a corresponding dialogue box, as shown in (a) to (d) of FIG. 12, for setting an output process.

The dialogue box can be displayed such that (i) the dialogue box fits in the display window of the search result or (ii) the dialogue box bridges between the preview display window and the display window of the search result of (a) of FIG. 9.

(a) of FIG. 12 is a dialogue box for the print setting and is displayed in a case where printing is selected as the function. In the dialogue box, it is possible to select each of “number of copies”, “double-side printing”, “multi-shot printing”, and “color mode”. By clicking the button “▾” or “▴” located at one end of each of blocks of the “number of copies”, the “double-side printing”, the “multi-shot printing”, and the “color mode”, it is possible to select an option from selectable conditions in each of the blocks.

In a case where, for example, the “double-side printing” is selected, clicking of the button “▾” allows setting of the “double-side printing” to “double-side printing” or “single-side printing”.

In a case where the “multi-shot printing” is selected, clicking of the button “▾” allows setting of the “multi-shot printing” to, for example, “1 in 1”, “2 in 1”, “4 in 1”, or “8 in 1”. Note, however, that the setting of the “multi-shot printing” is finally determined by the setting made via the dialogue box, illustrated in FIG. 4, of the compatible format data generating section 21. Hence, in a case where the “multi-shot printing” is set to “2 in 1” in the dialogue box of the compatible format data generating section 21 and further is set to “2 in 1” in the dialogue box of (a) of FIG. 12 also, the printing carried out in the image output device 10 results to be the “4-in-1” printing.

In a case where the “color mode” is selected, clicking of the button “▾” allows setting of the “color mode” to “color” or “monochrome”. In a case where the “color” is selected, color printing is carried out. In a case where the “monochrome” is selected, monochrome printing is carried out.

In a case where an “OK” button is clicked on the window, the disclosure reception section 26 (i) receives (a) entered conditions for the print settings and (b) an instruction to execute printing, (ii) transmits these conditions and instruction to the command generating section 24 to instruct the command generating section 23 to create a command, and instructs the communication section 25 to transmit, to the selected image output device 10, the created command and the compatible format data.

(b) of FIG. 12 is a dialogue box for facsimile transmission setting and is displayed in a case where the “facsimile transmission” is selected as the function. In the dialogue box, it is possible to set a “facsimile number” and “communication speed”. The “facsimile number” is entered by use of a keyboard (not shown) or the like. By clicking a button “▾” located at one end of a block of the “communication speed”, it is possible to select an option from the selectable conditions in the block.

In a case where an “OK” button is clicked on the window, the reception section 26 (i) receives (a) entered conditions for the facsimile transmission setting and (b) an instruction to execute facsimile transmission, (ii) transmits these conditions and instruction to the command generating section 23 to instruct the command generating section 24 to create a command, and (iii) instructs the communication section 25 to transmit, to the selected image output device 10, a created command and the compatible format data.

(c) of FIG. 12 is a dialogue box for Internet-facsimile transmission settings and is displayed in a case in which an “Internet-facsimile transmission” is selected as the function. In the dialogue box, an “e-mail address”, “compression format”, and “request for transmittal confirmation” are set. The “e-mail address” is entered by use of a keyboard (not shown) or the like. By clicking a button “▾” located at one end of blocks of the “compression format” and the “request for transmittal confirmation”, it is possible to select an option from selectable conditions of each of the blocks.

In a case where a button “OK” is clicked on the window, the disclosure reception section 26 (i) receives (a) entered conditions for the Internet-facsimile transmission setting and (b) an instruction to execute the Internet-facsimile transmission, (ii) transmits these conditions and instruction to the command generating section 24 to instruct the command generating section 24 to create a command, and (iii) instructs the communication section 25 to transmit, to the selected image output device 10, a created command and the compatible format data.

(d) of FIG. 12 illustrates a dialogue box for e-mail transmission setting that is displayed in a case where the “e-mail transmission” is selected. In this window, the “e-mail address”, “file format”, “color mode”, and “compression format” are set. The “e-mail address” is entered via a keyboard or the like (not illustrated). By clicking a button “▾” located at one end of blocks of the “e-mail address”, “file format”, “color mode”, and “compression format”, it is possible to select an option from selectable conditions of each of the blocks.

Here also, when an “OK” button is clicked on the window, the disclosure reception section 26 (i) receives (a) entered conditions of the e-mail transmission settings and (b) an instruction to execute the e-mail transmission, (ii) transmits these conditions and instruction to the command generating section 24 to instruct the command generating section 24 to create a command, and (iii) instructs the communication section 25 to transmit, to the selected image output device 10, the created command and the compatible format data.

In a case where, for example, it is determined that the image output device 10 does not have a double-side printing function, on the basis of the information obtained from the image output device 10, the block of the “double-side printing” may show the setting of “single-side printing” in grayed out display and disable the selection of the double-side printing block even if the button “▾” is clicked on in the dialogue box for the print setting, as shown in (a) of FIG. 13.

In a case where the “double-side (side-stapled)” is set in the dialogue box for setting the output setting in the print process (specification window of print setting) illustrated in (a) of FIG. 6, no image output device 10 that does not have such a double-side printing function will be displayed on the display window of the search result.

In many of the image output devices 10 that have the double-side printing function, it is possible to specify whether to have sheets of printing paper side-stapled or top-stapled in double-side printing. In view of the circumstances, it is possible to have a configuration, as shown in (b) of FIG. 13, in which clicking of the button “▾” located at one end of the block for the “double-side printing” causes a display of three options, “single-side printing”, “double-side printing (side-stapled)”, and “double-side printing (top-stapled)”, and the user is to select one of these options.

Note that, when a “cancel” button is clicked, on the dialogue boxes of (a) through (d) of FIG. 12 and (a) and (b) of FIG. 13, the display window returns to the window with the popup menu for selecting the output process, illustrated in (a) and (b) of FIG. 10 or (a) and (b) of FIG. 11.

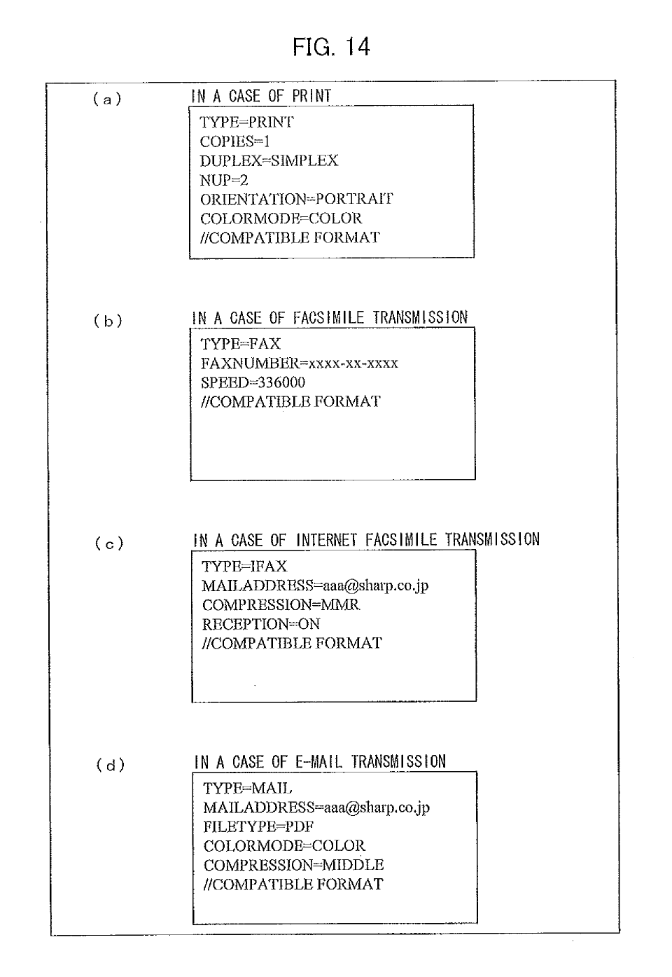

Shown in (a) through (d) of FIG. 14 are examples of commands to be generated by the command generating section 24 in the information processing device 20.

(a) of FIG. 14 shows an example of commands corresponding to a case in which printing is selected as the function. The commands are generated in a case where the button “OK” is clicked in the dialogue box of (a) of FIG. 12 in a state in which the dialogue box has been set as shown in (a) of FIG. 12.

“TYPE=PRINT” indicates that the output process is the printing. “COPIES=1” indicates that the number of copies is one (1). “DUPLEX=SIMPLEX” indicates single-side printing. “NUP=2” indicates the 2-in-1 multi-shot printing. “ORIENTATION=PORTRAIT” indicates a vertical paper orientation, “COLORMODE=COLOR” indicates color printing. Generated commands are added before “//compatible format data”.

(b) of FIG. 14 shows an example of commands corresponding to a case where facsimile transmission is selected as the function. The commands are generated in a case where the button “OK” is clicked in the dialogue box of (b) of FIG. 12 in a state in which the dialogue box has been set as shown in (b) FIG. 12.

“TYPE=FAX” indicates that the output process is the facsimile transmission. “FAXNUMBER=xxxx-xx-xxxx” indicates a telephone number of a transmission destination to which the facsimile transmission is made. “SPEED=336000” indicates a communication speed. Generated commands are added before “//compatible format data”.

(c) of FIG. 14 shows an example of commands corresponding to a case where “Internet-facsimile transmission” is selected as the function. The commands are generated in a case where the button “OK” is clicked in the dialogue box of (c) of FIG. 12 in a state in which the dialogue box has been set as shown in (c) of FIG. 12.

(d) of FIG. 14 shows an example of commands corresponding to a case in which the e-mail transmission is selected as the function. The commands are generated in a case in which the button “OK” is clicked in the dialogue box of (d) of FIG. 12 in a state in which the dialogue box has been set as shown in (d) of FIG. 12.

“TYPE=MAIL” indicates that the output process is the e mail transmission. “MAILADDRESS=aaa@sharp.co.jp” indicates an e-mail address of a transmission destination of the e-mail transmission. “FILETYPE=PDF” indicates that the file format is PDF. “COLORMODE=COLOR” indicates color mode. “COMPRESSION=MIDDLE” indicates that the compression format is of medium level compression. Generated commands are added before “//compatible format data”.

“TYPE=IFAX” indicates that the output process is the Internet-facsimile transmission. “MAILADDRESS=aaa@sharp.co.jp” indicates an email address of a transmission destination to which the Internet-facsimile transmission is made. “COMPRESSION=MMR” indicates that the compression format is of MMR compression. “RECEPTION=ON” indicates that transmittal confirmation is required. Generated commands are added before “//compatible format data”.

The command analysis section 12 of the image output device 10 which has received the compatible format data analyzes the commands added before the “//compatible format data”, to determine (i) a process to be carried out by the image output processing section 13 and (ii) print settings, address settings or the like.

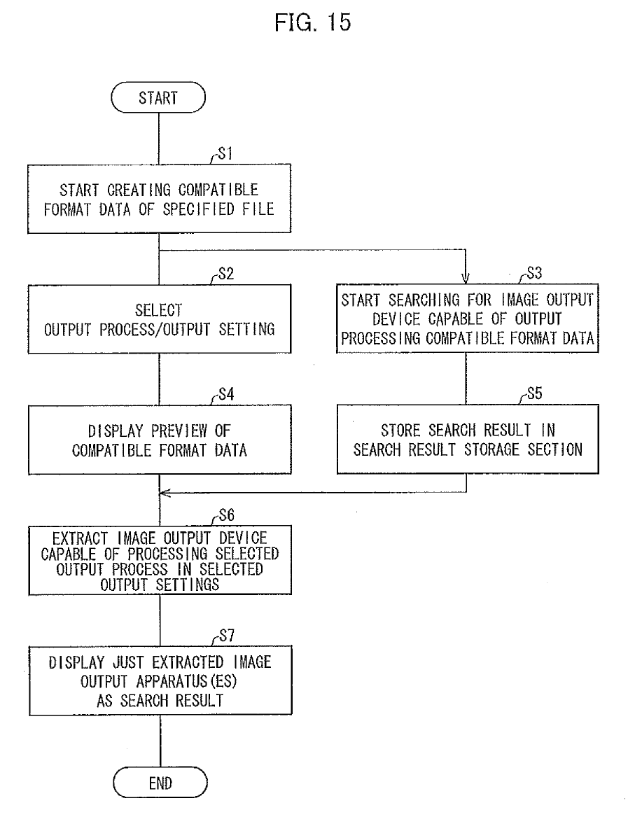

The flowchart of FIG. 15 shows a sequence of processes carried out in the information processing device 20, started by the user instructing the information processing device 20 to generate the compatible format data.

Upon detecting (i) a clicking of the button “print” of the print window (see FIG. 3) in a state in which the file of the application data is open or (ii) a dragging and dropping of, onto an icon for activating the compatible format data generating section 21, a file of the application data that is to be subjected to the output process, the compatible format data generating section 21 starts a process of generating the compatible format data of the application data (S1). In response to the compatible format data generating section 21 that starts to generate the compatible format data, the selecting section 22 causes selection of the output process and selection of the output settings (S2), and the searching section 23 starts searching for image output devices capable of processing the compatible format data (S3). Note that the selection of the output process in S3 and the search carried out by the searching section 23 in S3 can be started without waiting for the completion of the process in S1, and the processes of S2 and S3 are conducted concurrently.

After the output process and the output settings have been selected, the preview display editing section 31 starts a preview display on the user interface 29 of a preview image of the compatible format data (S4). Moreover, the searching section 23 stores obtained information in the storage section 28 (S5).

Based on the information of the search result stored in the storage section 28, the searching section 23 extracts just the information of the image output device 10 that is capable of carrying out the output process selected in S2 under the selected output settings (S6), and the disclosure reception section 26 displays this as a search result (S7). In the embodiment, the searching section 23 can successively extract the information of the image output device 10 capable of carrying out the selected output process in the selected output setting based on the obtained information, without waiting for the search to be completed, and have the disclosure reception section 26 display this information of the image output device 10. Moreover, there is no need to wait for the completion of the preview display in S3, in displaying the search result.

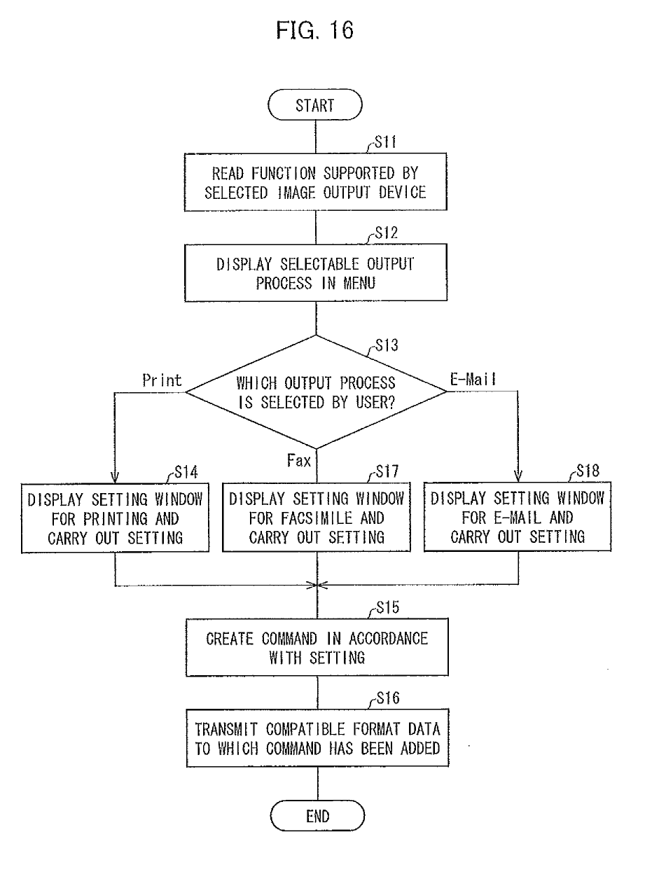

The flowchart of FIG. 16 shows a sequence of processes carried out in the information processing device 20 started by the user selecting the image output device 10 and the output process in the display window of the search result.

In a case where a clicking of the icon of one of the image output devices 10 is detected on the display window of the search result, the disclosure reception section 26 (i) reads out, from the storage section 28, corresponding information of the output process function(s) in which the compatible format data can be used and which is(are) supported by that image output device 10 (S11) and (ii) displays, as a menu, the reselectable output process function(s) (S12). The flowchart of FIG. 16 corresponds to a case in which it is possible to select any of three functions: “print”, “facsimile transmission”, and “e-mail transmission”.

When the user selects any one of the functions which have been displayed, the disclosure reception section 26 determines which function has been selected (S13). In a case in which the function “print” is selected, the disclosure reception section 26 displays the dialogue box for the print setting (see (a) of FIG. 12), so that the settings are received (S14). Alternatively, in a case in which the “facsimile transmission” is selected, the disclosure reception section 26 displays the dialogue box for the facsimile transmission setting (see (b) of FIG. 12), so that the settings are received (S17). Likewise, in a case in which the “e-mail transmission” is selected, the disclosure reception section 26 displays the dialogue box for the e-mail transmission setting (see (d) of FIG. 12), so that the settings are received (S18). When setting is completed in each of S14, S17, and S18 for the respective selected functions, that is, when the button “OK” is clicked on each of the dialogue boxes of (a) through (c) of FIG. 12, the disclosure reception section 26 (i) receives the settings, (ii) determines that an instruction for execution has been given, and (iii) transmits the settings to the command generating section 24. Thereafter, the command generating section 24 generates a command in accordance with the settings (S15). When the command is generated, the communication section 25 transmits, to the selected image output device 10, the compatible format data to which the command has been added.

As described above, according to the information processing device 20 of the present embodiment, image output devices 10 available on the network 5 which are capable of using compatible format data can be found for output processes that are capable of using the compatible format data other than the printing function, for example facsimile transmission, Internet-facsimile transmission, e-mail transmission, or FTP transmission.

Moreover, the foregoing configuration allows for narrowing down the extracted image output devices 10 to just those that can carry out the desired output process, by the configuration including the selecting section 22. Hence, the desired output process can be carried out by any of the image output devices 10 among the selected image output devices 10. As a result, it is possible to promptly select the image output device 10 by which the process is carried out, to promptly carry out the output process.

Moreover, in the information processing device 20, the selecting section 22, in addition to allowing selection of any output process, allows for selecting the output settings for the output process. This makes the searching section 23 extract the image output devices 10 that are capable of carrying out the selected output processes in the selected output settings. Accordingly, if there is a desired output setting, it is possible to easily and promptly select the image output device 10 with which the process is carried out, by narrowing down the selection by adding the output settings into the conditions.

For example, if the function “time designation” is desirably used in the “facsimile transmission”, the user selects the “facsimile transmission” as the output process, and selects “time designation” in its output settings. As a result, just the image output devices 10 capable of at least “time designation process of the facsimile transmission” are extracted. Consequently, it is possible to reduce the trouble for finding an image output device that can carry out the “time designation process of the facsimile transmission” among the image output devices capable of outputting the compatible format data.

### Second Embodiment

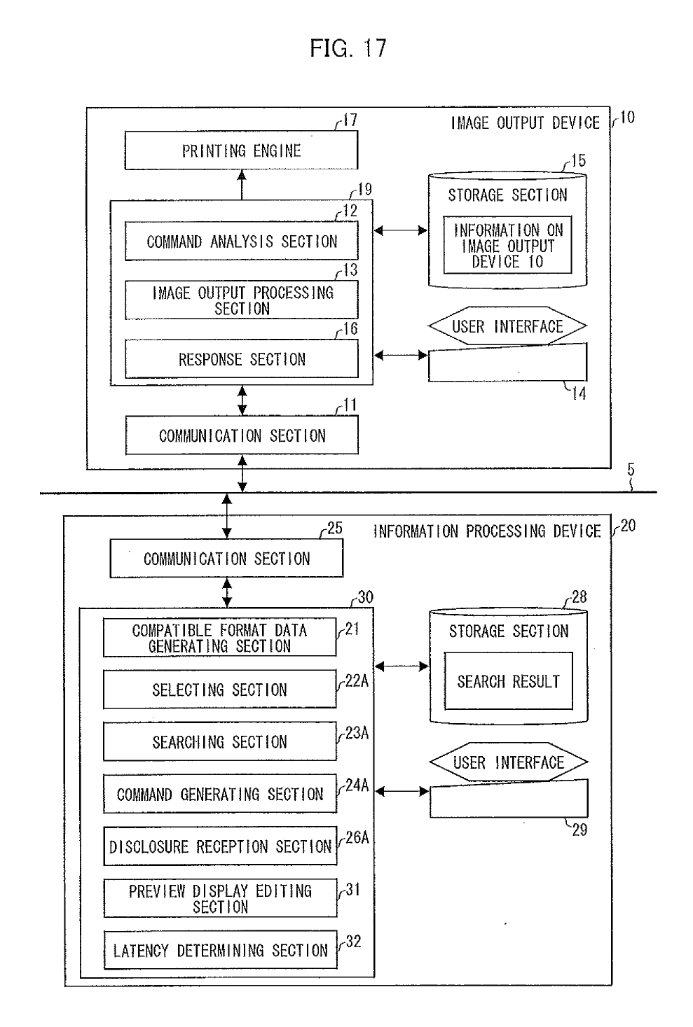

Described below is another embodiment of the present invention, with reference to FIGS. 17 through 20. For easy explanation, members having identical functions as the members used in First Embodiment are provided with identical reference signs, and explanations thereof are omitted in the present embodiment.

The information processing device according to the present embodiment basically has a similar configuration as the information processing device 20 of First Embodiment. Differences therebetween is that, instead of the selecting section 22, the searching section 23, the command generating section 24, and the disclosure reception section 26, the information processing device of the present embodiment includes a selecting section 22A, a searching section 23A, a command generating section 24A, and a disclosure reception section 26A, respectively, as illustrated in FIG. 17.

The selecting section 22A allows for selecting a plurality of output processes. The searching section 23A extracts just the image output device(s) 10 that can carry out the selected plurality of output processes in one device. The disclosure reception section 26A enables setting of output settings for each of the selected plurality of output processes in a respective one image output device 10. The command generating section 24A generates a command for causing the output processes based on entered respective output settings.

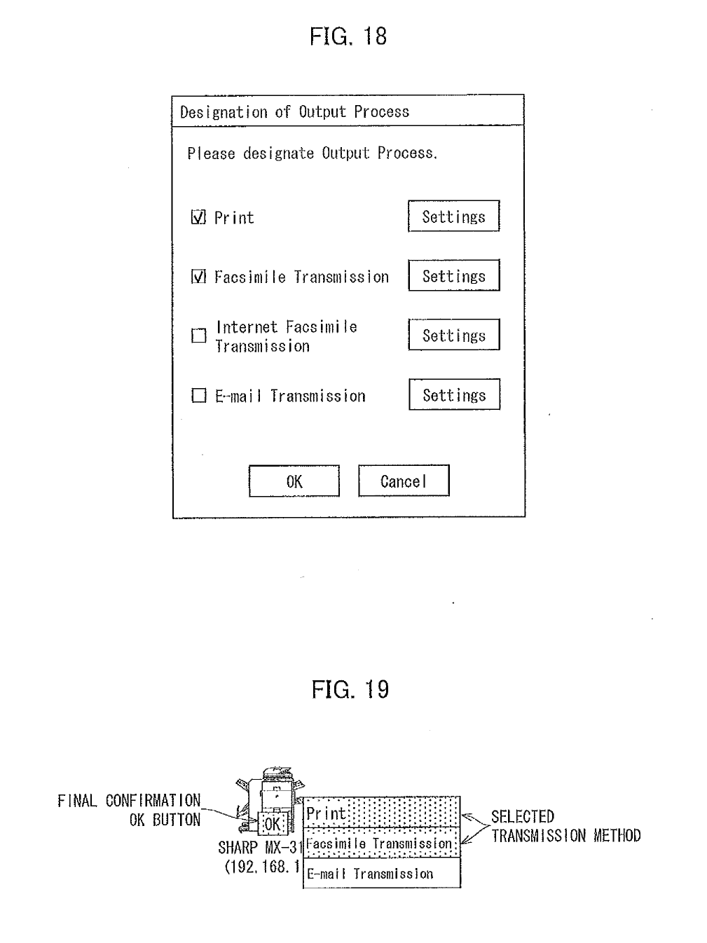

FIG. 18 illustrates a dialogue box displayed in the selecting section 22A, for the user to select (designate) the output process (output method). As illustrated in FIG. 18, the selecting section 22A in the information processing device of the present embodiment enables to select a plurality of functions among the four items “print”, “facsimile transmission”, “Internet-facsimile transmission”, and “e-mail transmission”, in a dialogue box for selecting the output process.

In the example of FIG. 18, the functions “print” and “facsimile transmission” have been selected. In a case where the “OK” button is clicked with such details, the searching section 23 extracts an image output device 10 that is capable of carrying out both the functions “print” and “facsimile transmission”.

In the case in which a plurality of output processes are selected, clicking of an icon of a displayed image output device 10 on a display window of a search result causes display of a popup menu for selecting an output process among all the output processes that the clicked image output device 10 can process with use of compatible format data, as illustrated in FIG. 19.

Here, for instance if “print” is clicked, a dialogue box for carrying out the output settings for printing, as like the dialogue box illustrated in (a) of FIG. 12, is displayed. After the output setting is set in the dialogue box and the “OK” button is clicked, the display returns to the popup menu of FIG. 19. At this time, the color of the menu of “print” changes, to make it apparent that the output settings have been set.

In this state, thereafter, clicking on the “facsimile transmission” causes display of a dialogue box for setting the output settings of the facsimile transmission, as illustrated in (b) of FIG. 12. After the output setting is set in the dialogue box and the “OK” button is clicked, the display returns to the popup menu of FIG. 19. At this time, the color of the menu of “facsimile transmission” also changes, to make it apparent that the output settings are set.

Thereafter, by clicking the “OK” button for final confirmation illustrated in FIG. 19, the output process and respective output settings are fixed. This causes the command generating section 24A to generate commands for the functions “print” and “facsimile transmission”.

Of course, if the configuration is to be made so that no changes are accepted from the processes selected in the selecting section 22, there is no need to display the popup menu illustrated in FIG. 19. Namely, the configuration may be one in which, by clicking on the icon of the image output device 10 on the display window of the search result, a dialogue box for setting the output settings of the selected output processes as illustrated in (a) to (d) of FIG. 12 are displayed successively, and by clicking the “OK” button in the dialogue box displayed last, the output process is set and the command generating section 24 generates a respective command.

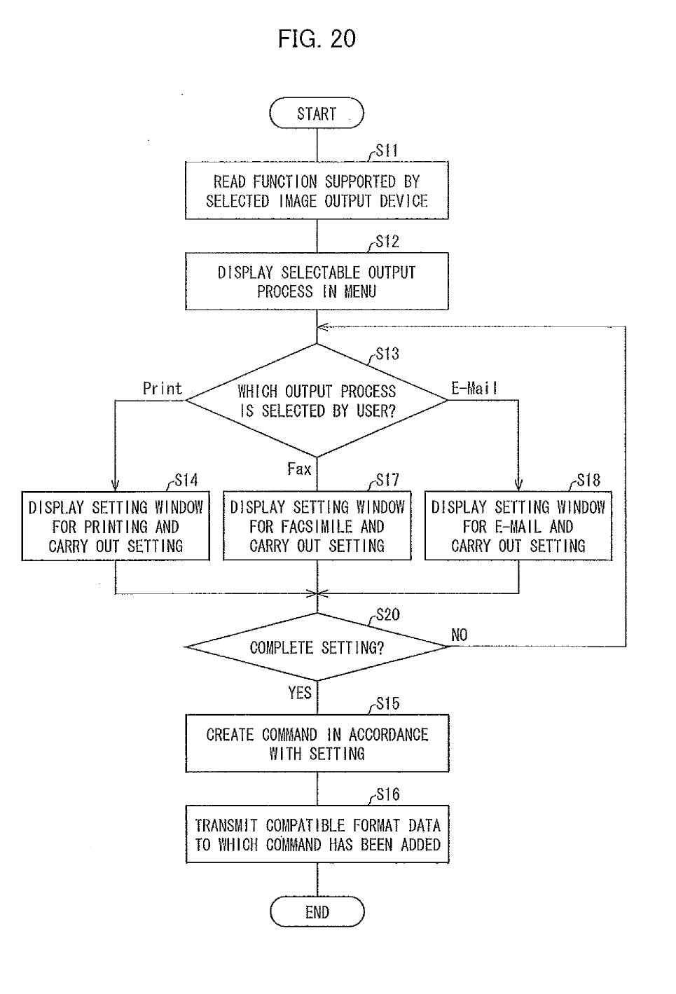

The flow chart of FIG. 20 illustrates a sequence of processes in the information processing device of the present embodiment, which sequence starts by the user selecting (reselecting) an image output device 10 and an output process on the display window of the search result.

As seen as a result of comparison with the flow chart of FIG. 16 described in First Embodiment, the flow chart of FIG. 20 includes S20 before S15 in which confirmation is made on whether or not all settings have been made. In 820, when the “OK” button for final confirmation as illustrated in FIG. 19 is clicked, S20 is determined as a YES, whereby the process proceeds to S15. Until the “OK” button for final confirmation is clicked, the process returns to S13. This allows for selecting a plurality of output processes and for setting output settings for each of the output processes.

In S15, a command corresponding to each of the plurality of output processes is generated, which output processes are each set with output settings. For instance, in a case where the user selects the functions “print” and “facsimile transmission”, a printing command+a facsimile command is generated. In S16, one compatible format data is attached with the printing command+facsimile command, and is transmitted. Even if a plurality of output processes were selected, the transmission of the compatible format data is required only once.

As such, in the configuration, (i) the selecting section 22A allows for selecting a plurality of output processes, (ii) the searching section 23A extracts an image output device(s) 10 capable of carrying out the selected plurality of output processes all in the one device, (iii) the disclosure reception section 26A causes entry of output settings to each of the selected plurality of output processes, and (iv) the command generating section 24A generates a command for executing the selected plurality of output processes based on a respective output setting entered.

This allows for easily finding the image output device 10 which is capable of carrying out the plurality of output processes in the one device, and instructs a process with few procedures in a case where the same data is desirably transmitted by facsimile simultaneously with the printing. Since the trouble to find the image output device 10 capable of carrying out the desired plurality of output processes in one device is reduced, the convenience of the information processing device improves.

### Third Embodiment

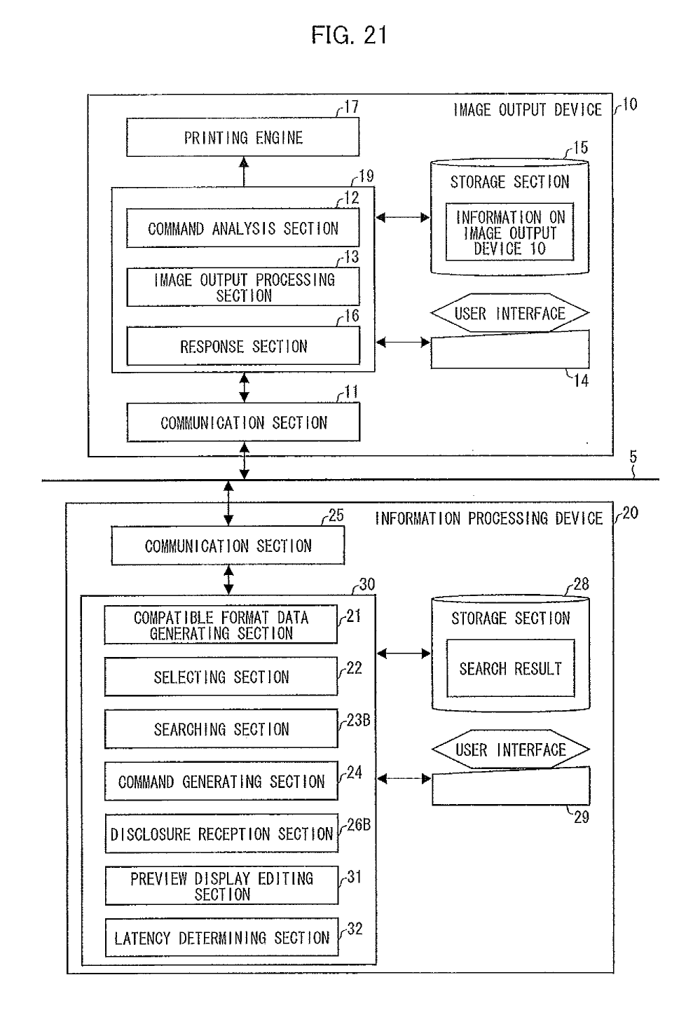

Described below is another embodiment of the present invention, with reference to FIGS. 21 through 25. For easy explanation, members having identical functions as those used in First and Second Embodiment are provided with identical reference signs, and their descriptions have been omitted.

The information processing device according to the present invention basically has a similar configuration as the information processing device 20 of First Embodiment. Differences therebetween is that, as illustrated in FIG. 21, instead of the searching section 23 and the disclosure reception section 26, the information processing device of the present embodiment includes a searching section 23B and a disclosure reception section 26B.

In a case where no image output device 10 which can at least carry out the output process selected by the selecting section 22 in the selected output settings is available, the searching section 23B extracts an alternative image output device 10 which is capable of carrying out the selected output process in output settings other than the selected output settings.

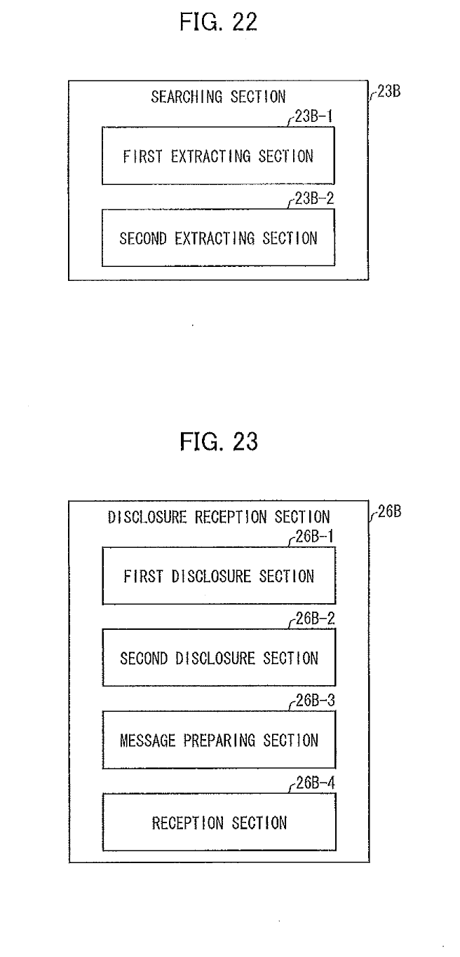

FIG. 22 is a block diagram specifically illustrating the searching section 23B. The searching section 23B includes a function of the second extracting section 23B-2, in addition to the function of the first extracting section 23B-1 included in the searching section 23.

The first extracting section 23B-1 extracts an image output device(s) 10 which at least is(are) capable of carrying out the output process selected by the selecting section 22 in the selected output settings. In a case where no image output device 10 is extracted by the first extracting section 23B-1, the second extracting section 23B-2 extracts an alternative image output device(s) 10 which is(are) capable of carrying out the selected output process in output settings other than the selected output settings.

Information on the image output device(s) extracted by the first extracting section 23B-1 and the second extracting section 23B-2, and output settings that can be set in that image output device(s), are outputted to the disclosure reception section 26B.

In the case where an alternative image output device(s) 10 is extracted by the second extracting section 23B-2 of the searching section 23B, the disclosure reception section 26B discloses the alternative image output device(s) 10 together with a message suggesting to change the output settings.

FIG. 23 is a block diagram specifically illustrating the disclosure reception section 26B. The disclosure reception section 26B, in addition to functions of a first disclosure section 26B-1 and a reception section 26B-4 included in the disclosure reception section 26, includes functions of a second disclosure section 26B-2 and a message preparing section 26B-3.

The first disclosure section 26B-1 discloses the image output device 10 extracted by the first extracting section 23B-1 of the searching section 23B with use of the user interface 29, and causes the user to (i) select the image output device 10 serving as a transmission destination of the compatible format data and (ii) input the output settings, by use of the user interface.

In the case where an alternative image output device(s) 10 is extracted, the second disclosure section 26B-2 discloses the alternative image output device(s) 10 together with a message suggesting the user to change the output settings.

The message preparing section 26B-3 prepares the message disclosed by the second disclosure section 26B-2. The message preparing section 26B-3 compares the output settings that can be set in the extracted alternative image output device(s) 10 with the output settings selected by the user in the selecting section 22, and prepares a message suggesting the user to change the output setting of the selected output process to an output setting that can be set in the alternative image output device(s) 10.

For example, in a case where the user selects “color” as an output setting in “print” however no image output device 10 which can print in color is detected, and as an alternative device, an image output device 10 which can print in black and white is extracted, the message preparing section 26B-3 prepares a message which suggests the user to change the output setting of “color” to the monochrome printing.

Moreover, in a case where the user selects “staple” as an output setting in the function “print” however no image output device 10 that can carry out the staple process is detected, and an image output device 10 not having the staple function is extracted as an alternative device, the message preparing section 26B-3 prepares a message which suggests to take away the designation of the staple process, since the alternative image output device 10, even though it cannot carry out the stapling process, it still can carry out just the print process.

Moreover, in a case where the user selects “compression format: MMR” as an output setting in the “facsimile transmission” however no image output device 10 that can compress data in the “MMR” format is detected and an image output device 10 capable of compressing data in “MR” is extracted as an alternative, the message preparing section 26B-3 prepares a message to suggest the user to change the compression format to “MR”.

After the user (i) selects an image output device 10, (ii) enters its output settings and (iii) instructs to execute the process, each on a window disclosed by the first disclosure section 26B-1 or by the second disclosure section 26B-2, the reception section 26B-4 receives the entry and instruction. The detail received at the reception section 26B-4 is outputted to the command generating section 24.

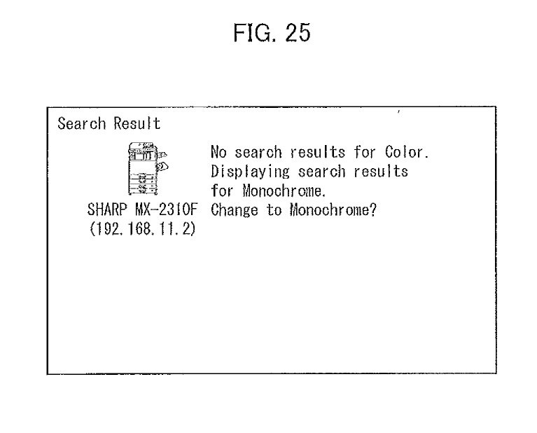

FIG. 25 illustrates an example of a display window of a search result in a case where “color” is selected in the function “print” however no image output device 10 capable of the color printing was detected, and alternatively, an image output device 10 capable of black and white printing is extracted. The display window displays an image output device 10 “SHARP MX-2310F” capable of monochrome image display and a message which writes “No search results for Color. Displaying search result for Monochrome. Change to monochrome?”.

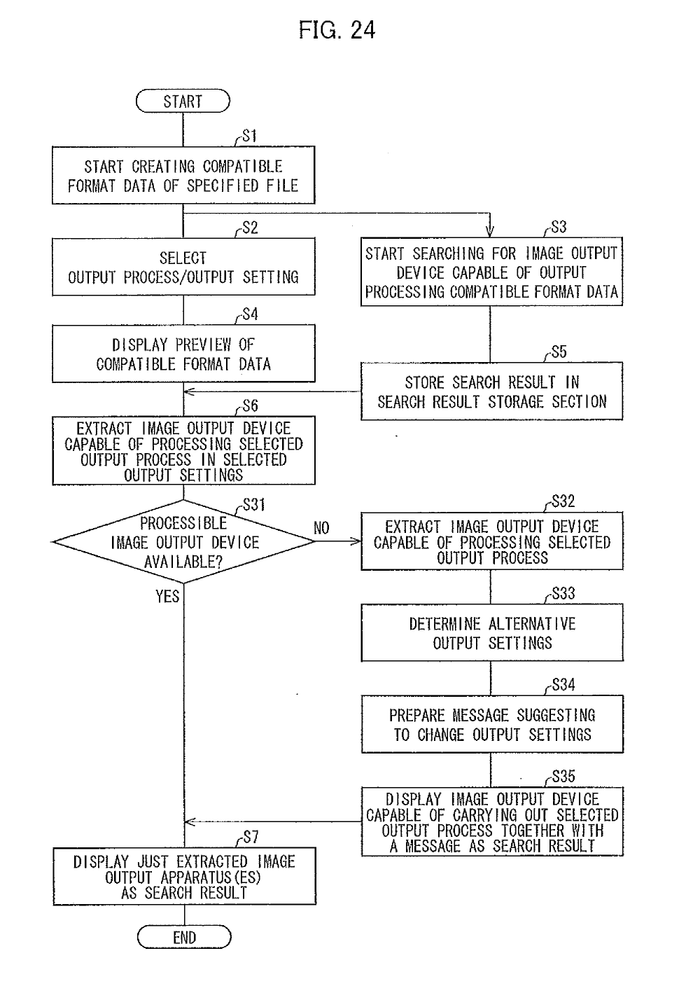

The flow chart of FIG. 24 illustrates a sequence of processes carried out in the information processing device of the present embodiment, the processes being started by the user instructing to generate the compatible format data.

As clear by comparing with the flow chart of FIG. 15 described in First Embodiment, the flow chart in FIG. 24 includes, between S6 and S7, a step S31 determining whether or not an image output device 10 processible in S6 is extracted. If it is determined as YES in this step, the process proceeds to S7.

If it is determined as NO in S31, the process proceeds to S32, and an image output device(s) 10 which can carry out the selected output process regardless of the selected output setting is extracted. In S33, an alternative output setting that can be set in the alternative image output device extracted in 532 is determined, and in S34, a message is prepared which suggests the user to change the output settings from that selected in S2 (see FIG. 15) to the alternative output settings determined in S33. In S35, the disclosure reception section 26 displays, together with the message prepared in S34, the alternative image output device 10 which can carry out the output process in the alternative output settings.

As such, in the foregoing configuration, in the case where no image output device 10 is available which can at least carry out the output process selected by the selecting section 22 in the output setting selected by the selecting section 22, the searching section 23B extracts an alternative image output device(s) 10 which can carry out the selected output process in output settings other than the selected output settings, and in a case where the alternative image output device(s) 10 is extracted by the searching section 23B, the disclosure reception section 26B discloses the alternative image output device(s) 10 together with a message suggesting the user to change the output settings to one that enables execution of the process by the alternative image output device(s) 10.

As a result, an alternative output setting is suggested even if the output process cannot be carried out in the output settings selected by the user. By selecting the alternative output settings, the user can have the output process be carried out. This improves convenience of the information processing device.

### Fourth Embodiment

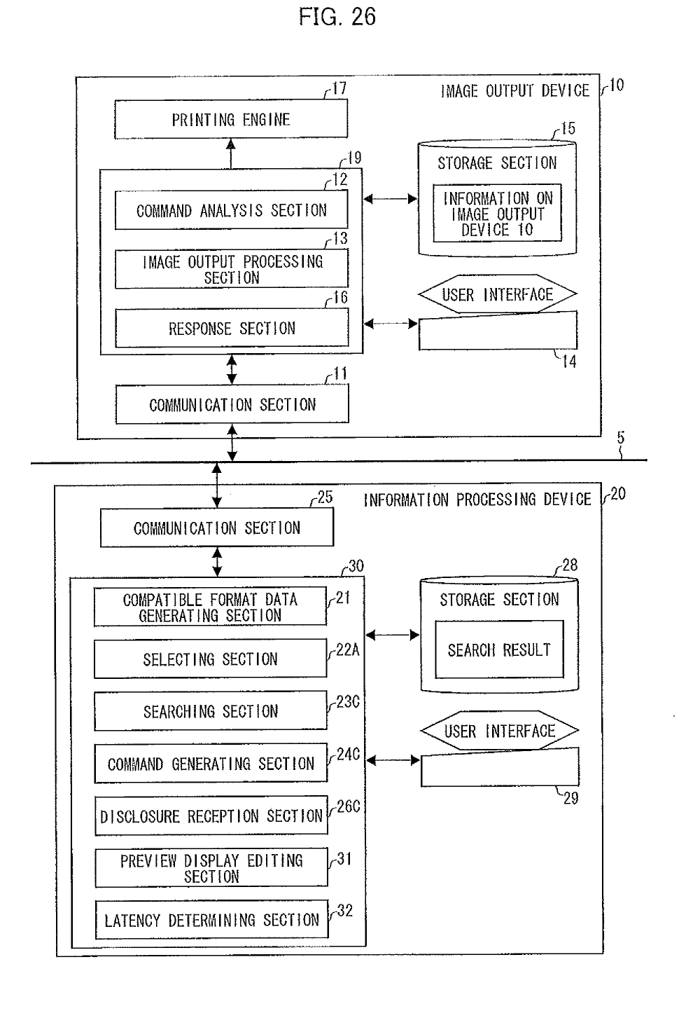

Another embodiment of the present invention is described below, with reference to FIGS. 26 through 28. For easy explanation, members having identical functions as those used in First, Second and Third Embodiments are provided with identical reference signs, and their descriptions are omitted in the present embodiment.

The information processing device according to the embodiment of the present invention basically has a similar configuration as the information processing device of First Embodiment. Differences therebetween is that, as illustrated in FIG. 26, the information processing device of the present embodiment includes the selecting section 22A instead of the selecting section 22, and instead of the searching section 23, the command generating section 24, and the disclosure reception section 26, the information processing device of the present embodiment includes a searching section 23C, a command generating section 24C, and a disclosure reception section 26C.

As described above, the selecting section 22A allows for selecting a plurality of output processes.

The searching section 23C extracts an image output device which at least can carry out any one of the selected plurality of output processes. Moreover, the disclosure reception section 26C causes the user to select the image output device 10 and to set the output setting for each of the selected output process. The command generating section 24C generates a command for each image output device selected as a device with which a respective output process is carried out, to cause execution of the selected output processes based on the selected output setting.

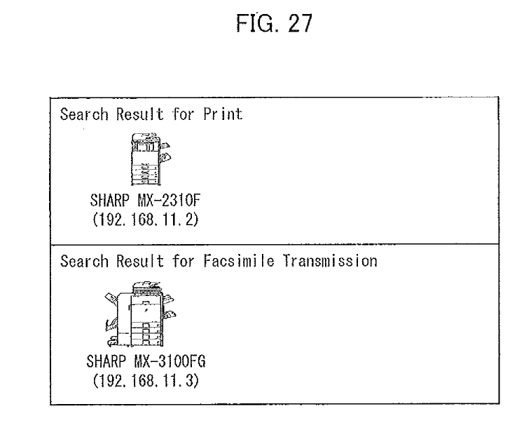

FIG. 27 illustrates an example of a display window of a search result displayed in the selecting section 22A, in a case where the functions “print” and “facsimile transmission” are selected in a dialogue box illustrated in FIG. 18 for the user to select (designate) an output process (output method). In the example of FIG. 27, the image output device 10 of “SHARP MX-2310F” capable of carrying out the function “print” and the image output device 10 of “SHARP MX-3100FG” capable of carrying out the function “facsimile transmission” are extracted separately and are displayed as each of the search results.

Thereafter, by clicking an icon of a desired image output device 10 for each output process on the window on which such a search result is displayed, it is possible to select the image output device 10 to which the compatible format data is transmitted and with which the respective output process is carried out. Although the example in FIG. 27 only has detected one image output device 10 per output process, there of course are cases where a plurality of image output devices 10 are detected, so therefore it is said to select a desired image output device 10.

If the icon of the image output device 10 of “SHARP MX-2310F” is clicked on the display window of the search result of the function “print” as illustrated in FIG. 27, the dialogue box for entering the output settings for printing is displayed, as illustrated in (a) of FIG. 12. Moreover, if the icon of the image output device 10 of “SHARP MX-3100FG” is clicked on the display window of the search result of the function “facsimile transmission” as illustrated in FIG. 27, a dialogue box for entering the output settings for facsimile transmission is displayed, as illustrated in (b) of FIG. 12.

The embodiment is of a configuration in which, when the icon of the image output device 10 displayed on the display window of the search result is clicked, a dialogue box for entering the output settings of the respective process is displayed. However, the configuration may be one in which the dialogue box for entering the output settings of the process is displayed after a step of displaying a popup menu is carried out, which popup menu is as illustrated in (a) and (b) of FIG. 10 and in (a) and (b) of FIG. 11 and is displayed for selecting the output process that can be carried out by the clicked image output device 10 among all output processes with which the compatible format data can be used.

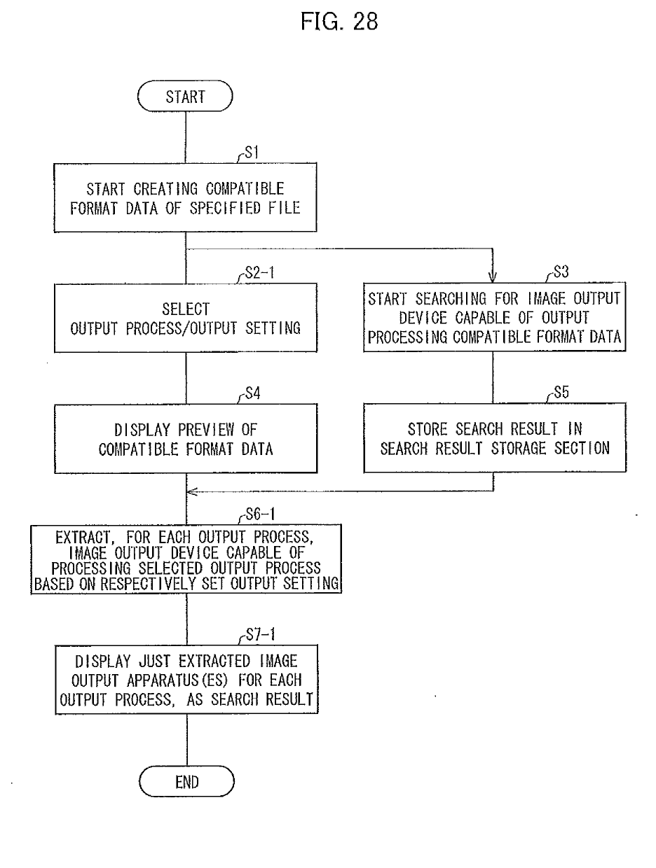

The flow chart of FIG. 28 illustrates a sequence of processes carried out in the information processing device of the present embodiment, which process is started by the user instructing to generate the compatible format data.

As clear from a result of comparison with the flow chart of FIG. 15 described in First Embodiment, the flow chart of FIG. 28 allows for the selecting section 22A to select a plurality of output processes and to select output settings for each of the output processes, in S2-1. Thereafter, in S6-1, the searching section 23C extracts, for each of the output processes, information of the image output device(s) 10 capable of carrying out that output process in the output settings respectively selected per output process in S2-1, based on the information of the search result stored in the storage section 28. In S7-1, the disclosure reception section 26 displays the image output device(s) 10 extracted for each of the output processes, as a search result for each of the output processes.

As such, in the foregoing configuration, (i) the selecting section 22A allows for selecting a plurality of output processes, (ii) the searching section 23C extracts, for each of the selected plurality of output processes, just the image output device(s) 10 that is(are) capable of carrying out the output process, (iii) the disclosure reception section 26C causes the user to enter the output settings for each of the selected plurality of output processes, and (iv) the command generating section 24C generates a command for causing execution of the selected plurality of output processes so that the output processes are carried out based on the entered respective output settings.

Hence, it is possible to instruct to carry out, with use of a single piece of data, processes to a plurality of image output devices 10 in accordance with its use (output process). For example, the single piece of data may be printed out from an image output device 10 close to a meeting room, while simultaneously, the single piece of data may be made stored in the image output device 10 close to the user's seat.

### Fifth Embodiment

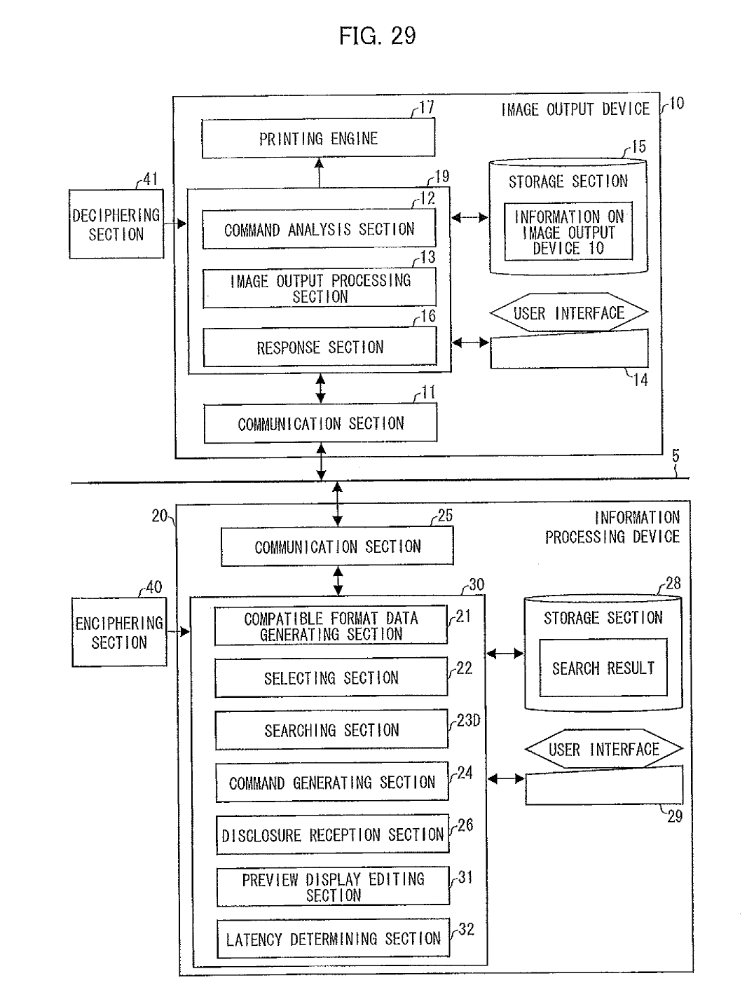

Another embodiment of the present invention is described below, with reference to FIG. 29. For easy explanation, members having identical functions as those used in First, Second, Third and Fourth Embodiment are provided with identical reference signs, and their descriptions are omitted.

The information processing device according to the embodiment of the invention basically has the same configuration as the information processing device as First Embodiment. Differences therebetween is that, as illustrated in FIG. 29, the information processing device according to the present embodiment includes a searching section 23D instead of the searching section 23, and further includes an enciphering section 40.

The enciphering section (format modification section) 40 modifies a format of the compatible format generated in the compatible format data generating section 21. The present embodiment exemplifies enciphering of the compatible format data.

The searching section 23D extracts just the image output device(s) 10 that is(are) capable of carrying out at least the output process selected in the selecting section 22 in the output settings selected in the selecting section 22, to the compatible format data enciphered by the enciphering section 40.

Namely, the searching section 23D searches the image output devices 10-1 through 10-N (see FIG. 2) connected on the network 5 via the communication section 25, and extracts an image output device(s) 10 including a deciphering section 41 and which is an image output device(s) 10 capable of carrying out at least the output process selected by the selecting section 22. The deciphering section 41 is a function of releasing the enciphered state of the compatible format data enciphered by the enciphering section 40.

As such, the foregoing configuration includes the enciphering section 40 which modifies a format of the compatible format data to encipher the compatible format data, and the searching section 23D extracts just the image output device(s) 10 capable of at least carrying out the selected output process or at least carrying out the selected output process in the selected output setting, to the enciphered compatible format data.

As a result, in a case where the compatible format data is of a special format such as that being enciphered, just an image output device 10 capable of handling such data is detected. This allows for using the compatible format data in the special format as it is, thereby improving the convenience of the information processing device.

The information processing device 20 of First Embodiment and the information processing devices of Second through Fifth Embodiments can be realized by use of a computer. In this case, (i) a program for causing the computer to operate as each section of the devices so as to realize the information processing device by use of the computer and (ii) a computer-readable recording medium in which the program is recorded, are also included in the scope of the present invention computer.

That is, in the embodiments, the sections (means) provided in the information processing device 20 of First Embodiment and the information processing devices of each of Second to Fifth Embodiments can be realized by means of software by use of a processor such as a CPU. In this case, the information processing device 20 of First Embodiment and the information processing devices of Second to Fifth Embodiments each includes a CPU (Central Processing Unit) for executing commands of a control program for implementing each function, a ROM (Read Only Memory) in which the program is stored, a RAM (Random Access Memory) on which the program is loaded, a storage device (recording medium), such as a memory, in which the program and various data are stored, and the like.

An object of the present invention is attained by the following procedures (i) and (ii): (i) loading, to each of the information processing device 20 of First Embodiment and the information processing devices of Second to Fifth Embodiments, the recording medium, in which program code (an executable program, an intermediate code program, and a source program) of the control program (software for implementing the functions) of each of the information processing device 20 of First Embodiment and the information processing devices of Second to Fifth Embodiments is recorded so as to be read out by a computer and (ii) causing the computer (or a CPU or an MPU) to read out and execute the program code recorded in the recording medium.

For example, a tape such as a magnetic tape or a cassette tape, a disk including (i) a magnetic disk such as a floppy (registered trademark) disk or a hard disk and (ii) an optical disk such as a CD-ROM, an MO, an MD, a DVD, or a CD-R, a card such as an IC card (including a memory card) or an optical card, a semiconductor memory such as a mask ROM, an EPROM, an EEPROM, or a flash ROM or the like can be used as the recording medium.

Further note that the information processing device 20 of First Embodiment and the information processing devices of Second to Fifth Embodiments can be configured so as to be capable of being connected to a communications network via which the program code is loaded to the information processing device 20. The communications network is not limited to a specific one. The communications network can be, for example, an internet, an intranet, an extranet, a LAN, an ISDN, a VAN, a CATV communications network, a virtual private network, a telephone network, a mobile telecommunications network, a satellite communication network or the like. A transmission medium that constitutes the communications network is not limited to a specific one. The examples of the transmission medium encompass (i) wired communications such as IEEE 1394, USB, a power-line carrier, a CATV line, a telephone line, or ADSL and (ii) wireless communications such as infrared communication by means of IrDA or remote control, Bluetooth (registered trademark), 802.11 wireless, HDR, a mobile phone network, a satellite circuit, or a terrestrial digital network. Note that the present invention can be realized also by means of a computer data signal embedded in a carrier wave, which computer data signal is obtained by embodying the program code in electronic transmission.

Note that sections (means) in the information processing device 20 of First Embodiment and the information processing devices of Second to Fifth Embodiments are not limited to ones that can be realized by means of software but can be configured as a hardware logic or a combination of hardware that partially carries out a process and arithmetic means that executes software for controlling the hardware or carrying out the rest of the process.

As described above, according to the present invention, it is possible to carry out an output process other than printing which are capable of using the compatible format data, for example facsimile transmission, Internet-facsimile transmission, e-mail transmission, or FTP transmission, with use of an image output device provided on the network, whose driver of the image output device is not installed in the image processing device.

The information processing device of the present invention may further be configured in such a manner that the selecting means enables to select a plurality of output processes, the searching means extracts just an image output device that is capable of carrying out the selected plurality of output processes all in one device, the disclosure/reception means receives an entry of an output setting for each of the selected plurality of output processes, and the command generating means generates a command for making the selected plurality of output processes be carried out based on the respectively entered output settings.

According to the configuration, by selecting a plurality of output processes in the selecting means, the searching means then extracts just an image output device(s) which can carry out the selected plurality of output processes in a single device. Hence, it is possible to easily find an image output device which can carry out a plurality of output processes with a single device, and can instruct to carry out processes with few procedures in a case where for example when a single piece of data is desirably printed and transmitted by facsimile simultaneously.

The information processing device of the present invention may further be configured in such a manner that the selecting means enables selection of a plurality of output processes, the searching means extracts, for each of the selected output processes, a respective image output device capable of carrying out the selected output process, the disclosure/reception means causes entry of the output setting for each of the selected plurality of output processes, and the command generating means generates a command for causing the selected plurality of output processes to be carried out based on their respective entered output settings.

According to the configuration, by selecting a plurality of output processes in the selecting means, the searching means extracts, for each of the selected plurality of output processes, just an image output device(s) capable of carrying out that output process. Hence, it is possible to instruct to carry out, with use of a single piece of data, processes to a plurality of image output devices 10 in accordance with its use (output process). For example, the single piece of data may be printed out from an image output device 10 close to a meeting room, while simultaneously, the single piece of data may be made stored in the image output device 10 close to the user's seat.

It is preferable that the information processing device of the present invention is further configured in such a manner that, in addition to selecting a given output process, the selecting means further causes selection of an output setting in the selected output process with use of the user interface, and the searching means extracts just an image output device capable of at least carrying out the output process selected by the selecting means in the output setting selected by the selecting means.

According to the configuration, the image output device extracted is narrowed down not only to an image output device capable of carrying out the desired output process, but further to an image output device capable of carrying out the desired output process in the desired output settings. Hence, as long as the image output device is one of the extracted image output devices, the desired output process can be carried out in the desired output settings. Thus, in a case of having a desired output setting, addition of that output setting into the conditions for the search to narrow down the search results allows for easily and promptly carrying out the selection of the image output device with which the process is carried out.

The information processing device of the present invention may further be configured in such a manner that the searching means further obtains information related to a current state of (a) an image output device that is capable of carrying out the output process selected by the selecting means or (b) an image output device that is capable of carrying out an output process selected by the selecting means in an output setting selected by the selecting means, the information processing device further includes latency determining means for determining a latency until the output process is started, based on the information related to an operational state of the image output device that is capable of carrying out the output process, and the disclosure/reception means discloses information of the latency determined by the latency determining means in such a manner that the information of the latency is associated with the image output device.

According to the configuration, latency determining means determines a latency until an output process is started based on information related to a current state of the image output device capable of carrying out the selected output process, which information is obtained by the searching means, and the disclosure/reception means discloses information of the determined latency in such a manner that this information is associated with the image output device.

Accordingly, when the image output device with which the output process is to be carried out is selected among the extracted image output devices, it is possible to select the image output device in consideration of time required for the output process to start. For example, in a case where a facsimile needs to be transmitted immediately, it is possible to clearly select an image output device that is in an immediate transmittable state.

The information processing device of the present invention may further be configured in such a manner that the searching means further obtains information related to a current state of (a) an image output device that is capable of carrying out the output process selected by the selecting means or (b) an image output device that is capable of carrying out an output process selected by the selecting means in an output setting selected by the selecting means, the information processing device further includes latency determining means configured to determine a latency until the output process is started, based on the information related to an operational state of the image output device that is capable of carrying out the output process, and the disclosure/reception means discloses the image output device extracted by the searching means in an order of short latency, based on the determination by the latency determination means.

According to the configuration, the extracted image output device is started in the order of short latency even if the latency is not specifically displayed. Hence, the user can preferentially select an image output device whose time until the output process is started is short.

It is preferable that the latency determining means has a configuration in which, for example, the latency is determined based on the operational state of the image output device and the number of jobs waiting to be processed. This allows for presenting an accurate latency.

The information processing device of the present invention may further be configured in such a manner that the searching means obtains information of an output process that can be carried out by the image output device other than that of the selected output process, at a time when extracting an image output device that is capable of at least carrying out the output process selected by the selecting means or at a time when just an image output device that is capable of at least carrying out the selected output process in the output setting selected by the selecting means, and the disclosure/reception means, in disclosing the image output device extracted in the searching means, discloses information of output processes other than that of the selected output process, and receives a change in selection of the output process to an output process other than the selected output process and an entry of output setting for the changed output process.

According to the configuration, if the extracted image output device is capable of carrying out an output process other than the selected output process, information of that output process other than the selected output process is also disclosed, so as to allow changing to another output process. Accordingly, for example even if a facsimile transmission of application data is requested and the image output device is narrowed down to those capable of carrying out the facsimile transmission, it is possible to, for example, switch the process over to Internet-facsimile transmission.

The information processing device of the present invention may further be configured in such a manner that, in a case where no image output device that is capable of at least carrying out the output process selected by the selecting means in the output setting selected by the selecting means is available, the searching means extracts an alternative image output device capable of carrying out the selected output process in an output setting other than the selected output setting, and in a case where an alternative image output device is extracted, the disclosure/reception means discloses the alternative image output device together with a message requesting to change the output setting to an output setting allowing for the output process to be carried out by the alternative image output device.

According to the configuration, in a case where no image output device capable of carrying out the selected output process in the selected output setting is available, the searching means extracts an alternative image output device capable of carrying out the selected output process in an output setting other than the selected output setting. In the case where an alternative image output device is extracted, the disclosure/reception means discloses the alternative image output device together with a message requesting to change the output setting to an output setting which allows for carrying out the output process by the alternative image output device.

Accordingly, even if the output process in the output setting selected by the user via the selecting means cannot be carried out, an alternative device is presented to the user, which allows for the user to have the output process be carried out by selecting the alternative device. This improves the convenience of the information processing device.

The information processing device may further be configured so as to include format modification means for modifying a format of the compatible format data, the searching means extracting an image output device that is capable of carrying out at least an output process selected by the selection means or an image output device that is capable of at least carrying out an output process selected by the selecting means in the output setting selected by the selecting means, to the compatible format data modified in format by the format modification means.

According to the configuration, the format modification means modifies a format of the compatible format data. The modification of the format by the format modification means is, for example, enciphering. The searching means extracts, with respect to the compatible format data in which its format is modified, an image output device that is at least capable of carrying out the output process selected by the selecting means.

In a case of compatible format data having a special format such as an enciphered compatible format data, the configuration allows for detecting just an image output device which can handle such data. Hence, it is possible to use the compatible format data of the special format as it is, thereby improving the convenience of the information processing device.

The image output system of the present invention includes the information processing device and an image output device connected to the information processing device via a network, the image output device being capable of an output process using the compatible format data.

The information processing device may be realized by a computer. In this case, a program realizing the information processing device by causing the computer to operate as each of means of the information processing device, and a computer-readable recording medium on which the program is stored, are also included in the scope of the present invention.

The present invention is not limited to the above-described embodiments but allows various modifications within the scope of the claims. That is, any embodiment derived from a combination of technical means appropriately modified within the scope of the claims, for example any embodiment derived from appropriately combining First to Fifth Embodiment, will also be included in the technical scope of the present invention.

### INDUSTRIAL APPLICABILITY

The present invention relates to an information processing device which assists an image output system in which given application data is used by being converted into compatible format data. The present invention allows printing, facsimile transmission and the like to be easily carried out by use of an image output device whose printer driver has not been installed in the information processing device.

### REFERENCE SIGNS LIST

5 network
6 wireless LAN access point
10 image output device
11 communication section
12 command analysis section
13 image output processing section
14 user interface
15 storage section
16 response section
17 printing engine
19 control section
20 information processing device
21 compatible format data generating section (data generating section)
22,22A selecting section
23,23A,23B,23C searching section
24,24A,24C command generating section communication section
26,26A,26B,26C disclosure reception section (disclosure/reception section)
28 storage section
29 user interface
30 control section
31 preview display editing section
32 latency determining section (time determining section)
40 enciphering section
X image output system

What is claimed is:

1. An information processing device comprising:
a data generating section configured to generate compatible format data of application data prepared based on an application program;
a selecting section configured to cause selection of an output process among a plurality of types of output processes capable of using the compatible format data;
a searching section configured to search an image output device connected via a network and extract just an image output device that is at least capable of carrying out the output process selected in the selecting section;
a disclosure/reception section configured to (i) disclose the image output device extracted by the searching section and (ii) receive (a) a selection of an image output device serving as a transmission destination of the compatible format data, (b) an entry of an output setting, and (c) an instruction for executing the output process; and
a command generating section configured to generate a command for causing the selected output process to be executed based on the entered output setting, upon receiving the instruction for executing the output process from the disclosure/reception section.

2. The information processing device according to claim 1, wherein
the selecting section enables to select a plurality of output processes,
the searching section extracts just an image output device that is capable of carrying out the selected plurality of output processes all in one device,
the disclosure/reception section receives an entry of an output setting for each of the selected plurality of output processes, and
the command generating section generates a command for making the selected plurality of output processes be carried out based on the respectively entered output settings.

3. The information processing device according to claim 1, wherein:
the searching section further obtains information related to a current state of an image output device that is capable of carrying out the output process selected in the selecting section,
the information processing device further comprises a latency determining section configured to determine a latency until the output process is started, based on the information related to an operational state of the image output device that is capable of carrying out the output process, and
the disclosure/reception section discloses information of the latency determined by the latency determining section in such a manner that the information of the latency is associated with the image output device.

4. An image output system comprising:
an information processing device; and
an image output device connected to the information processing device via a network, the image output device being capable of carrying out an output process that can use compatible format data, wherein
the information processing device comprises:
a data generating section configured to generate compatible format data of application data prepared based on an application program;
a selecting section configured to cause selection of an output process among a plurality of types of output processes capable of using the compatible format data;
a searching section configured to search an image output device connected via a network and extract just an image output device that is at least capable of carrying out the output process selected by the selecting section;
a disclosure/reception section configured to (i) disclose the image output device extracted by the searching section and (ii) receive (a) a selection of an image output device serving as a transmission destination of the compatible format data, (b) an entry of an output setting, and (e) an instruction for execution of the output setting; and
a command generating section configured to generate a command for causing the selected output process to be executed based on the entered output setting, upon receiving the instruction for executing the output setting from the disclosure/reception section.

5. A recording medium on which a program is stored, the program causing a computer to function as each of sections of an information processing device as set forth in claim 1.
